(19) United States
(12) Patent Application Publication
(10) Pub. No.: US 2025/0042148 A1
(43) Pub. Date: Feb. 6, 2025

(54) MULTI-APPLICATION MODULE, MULTI-APPLICATION DEVICE, AND WORKING METHOD FOR A MULTI-APPLICATION DEVICE

(71) Applicant: LEONHARD KURZ Stiftung & Co. KG, Fürth (DE)

(72) Inventor: Matthias MIEDERER, Fürth (DE)

(21) Appl. No.: 18/716,599

(22) PCT Filed: Nov. 28, 2022
(86) PCT No.: PCT/EP2022/083485

§ 371 Date: Jun. 5, 2024

(30) Foreign Application Priority Data
Dec. 9, 2021 (DE) 10 2021 132 416.5
Mar. 7, 2022 (DE) 10 2022 105 292.3

(51) Int. Cl. B41F 16/00; B41F 13/02; B41F 13/193; B41F 19/00; B41F 23/04; B41F 23/08; B41F 33/00

(52) U.S. Cl. CPC B41F 16/0013; B41F 13/025; B41F 13/193; B41F 16/0033; B41F 16/006; B41F 19/001; B41F 19/004; B41F 19/007; B41F 23/0409; B41F 23/08; B41F 33/0081

(57) ABSTRACT

A multi-application module (1), a multi-application device (2) and a working method for a multi-application device (2). The multi-application module (1) for printing on a substrate (6) or a transfer product (7) includes a printing unit (8) and a multifunctional element (9), wherein a printing nip (10) is formed between the printing unit (8) and the multifunctional element (9), and wherein the multifunctional element (9) has a first multifunctional roller (91) and/or at least one second multifunctional roller (92) and/or a printing table (13), and wherein the printing unit (8) is designed such that it can print along two running directions in the printing nip (10).

The invention relates to a multi-application module, a multi-application device and a working method for a multi-application device.

Substrates can be decorated in special printing and/or finishing devices by means of digital printing processes followed by application of transfer plies. By means of inkjet printing it is possible here on the one hand to apply an adhesive directly to the substrate in a printing device specially formed for this. On the other hand, by means of inkjet printing it is also possible to apply an adhesive to the transfer product in another printing device likewise specially formed for this. In both cases, the transfer product and the substrate are then brought together, with the result that the transfer plies of the transfer product that are to be applied adhere to the substrate, facilitated by the adhesive, and are further then detached from a carrier ply of the transfer product.

Thus, for example, a method and an application device for applying a transfer layer of a film to a substrate is known from WO 2016/150681 A1, wherein a radically curable adhesive is applied to a partial area of the transfer layer by means of an inkjet printhead.

A disadvantage of the above-named methods is in particular that for the application of the adhesive to the transfer product or to the substrate in each case they require printing and/or finishing devices specially formed for it, or until now only printing and/or finishing devices specially formed for it are known. Thus, for example, a special machine is required depending on whether the adhesive is now to be printed on the substrate or the transfer product, which in particular increases the mechanical complexity and thus the costs and further also means a lack of flexibility. This is in particular also because the print quality and/or the intended use differs between these two cases. Thus, for example, printing directly onto the substrate is usually associated with the adhesive running and/or soaking into the substrate, whereas printing onto the transfer product usually means additional work in aligning the transfer product with the substrate.

The object of the invention is now to provide an improved printing and/or finishing device and an improved (working) method for a printing and/or finishing device by means of which the disadvantages of the state of the art are preferably avoided.

This object is achieved by a multi-application module for printing on a substrate or a transfer product, comprising a printing unit and a multifunctional element, wherein a printing nip is formed between the printing unit and the multifunctional element, wherein the multifunctional element has a first multifunctional roller and/or at least one second multifunctional roller and/or a printing table, and wherein the printing unit is designed such that it can print along two running directions in the printing nip.

This object is further achieved by a multi-application device comprising a multi-application module according to the invention, in particular according to one of claims 1 to 21, and a cold transfer unit, wherein the cold transfer unit comprises a pressure roller and a counter-pressure roller.

This object is also achieved by a (working) method for a multi-application device, preferably a multi-application device according to the invention, further preferably according to one of claims 22 to 33, wherein, according to a first variant i), a substrate is guided along a multifunctional element to a printing nip formed between a printing unit and the multifunctional element in order to print on the substrate and is guided further to the one counter-pressure roller and a pressure roller, with which a transfer product is pressed onto the substrate, or wherein, according to a second variant ii), the transfer product is guided along the multifunctional element to the printing nip formed between the printing unit and the multifunctional element in order to print on the transfer product and is guided further to the counter-pressure roller and the pressure roller, with which the transfer product is pressed onto the substrate, and wherein the substrate and/or the transfer product, in variants i) and ii), are guided in each case in an opposing running direction, in particular in the multi-application module.

Through the multi-application module according to the invention, the multi-application device according to the invention and through the (working) method according to the invention for a multi-application device it is achieved that both variants, namely one for printing onto the substrate and one for printing onto the transfer product, can be carried out by means of one and the same machine, in particular one and the same printing and/or finishing device. This makes a flexible usage possible, by means of which the advantages of a printing, in particular in the form of an adhesive, onto the substrate or the transfer product can be utilized in a targeted manner without two machines needing to be provided for this. Thus, it is made possible, solely through the use of the multi-application module according to the invention in a finishing machine, to be able to print onto the substrate or onto the transfer product, since the multi-application module according to the invention makes it possible to print in two opposing running directions. In other words, both variants become possible on one machine using the multi-application module according to the invention through a change of the substrate path and transfer product path. The mechanical complexity and thus the costs are hereby reduced and at the same time the flexibility is increased, in order to choose the suitable variant for the respective application and thereby to obtain an optimum result.

By “mounted rotatable in two opposing rotational directions” is meant here that the first multifunctional roller and/or the at least one second multifunctional roller can rotate in two directions, thus can rotate clockwise and counterclockwise. The first multifunctional roller and/or the at least one second multifunctional roller in particular has an axis which makes both rotational directions possible. The axis of the first multifunctional roller and/or of the at least one second multifunctional roller is preferably the longitudinal axis of the first multifunctional roller and/or of the at least one second multifunctional roller and runs transversely with respect to the feed direction of the substrate and the transfer product.

By “two running directions” is meant here that the running directions or feed directions of the substrate and the transfer product differ or are opposing, in particular differ or are opposing in the area of the printing nip. Furthermore, depending on whether it is the substrate or the transfer product that is being guided, it is advantageous that the substrate to be printed on and the transfer product to be printed on move in opposite directions. Thus, it is possible, for example, that the substrate is printed on in the case of a running direction from left to right and the transfer product is printed on in the case of a running direction from right to left, or vice versa.

By “transfer product” is meant a transfer film comprising a carrier ply and a transfer ply, wherein the transfer ply is detachable from the carrier ply.

It is further expedient if the transfer film comprises a detachment layer, in particular which is arranged between the carrier ply and the, in particular detachable, transfer ply.

The detachment layer preferably has a layer thickness of between 0.01 μm and 10 μm, preferably between 0.1 μm and 5 μm, and/or consists of waxes, polyethylene (PE), polypropylene (PP), cellulose derivatives and/or poly(organo) siloxanes.

The transfer ply is preferably formed single- or multi-layered. Thus, it is possible that the transfer ply has a decorative ply, in particular wherein the decorative ply has one or more layers, selected from: opaque layers, translucent layers, transparent layers, colored varnish layers, replication varnish layers, metal layers, metal oxide layers.

It is possible here that the transfer ply in particular has a layer thickness of between 1 μm and 10 μm.

It is also possible that the carrier ply contains materials selected, individually or in combination, from: polyester, polyolefin, polyvinyl, polyimide (PI), acrylonitrile-butadiene-styrene (ABS), polyethylene terephthalate (PET), polypropylene (PP), polyethylene (PE), polyvinyl chloride (PVC), polystyrene (PS), and in particular has a layer thickness of between 5 μm and 50 μm, preferably between 7 μm and 23 μm.

The “substrate” is advantageously a single-layered or multi-layered plastic substrate, a single-layered or multi-layered paper substrate, or a multi-layered hybrid substrate, which has one or more paper plies and one or more plastic plies. It is also possible that the substrate comprises cotton fibers, wood fibers, pulp fibers, textile fibers and/or plastic fibers.

It is also conceivable to provide a multi-application module for printing on a substrate or a transfer product, wherein the multi-application module comprises a printing unit and a multifunctional element, wherein a printing nip is formed between the printing unit and the multifunctional element, and wherein the multifunctional element has a first multifunctional roller and/or at least one second multifunctional roller and/or a printing table, and wherein the multi-application module makes two running directions possible and makes it possible to print on the substrate in a first running direction of the two running directions and to print on the transfer product in a second running direction of the two running directions, in particular wherein the first and the second running directions are opposing.

In other words it is possible to provide a multi-application module for printing on a substrate or a transfer product, wherein the multi-application module comprises a printing unit and a multifunctional element, wherein a printing nip is formed between the printing unit and the multifunctional element, wherein the multifunctional element is formed for guiding the substrate or the transfer product, with the result that the substrate is printed on in the printing nip when the substrate is guided on the multifunctional element, in particular in a first running direction, and that the transfer product is printed on in the printing nip when the transfer product is guided on the multifunctional element, in particular in a second running direction, opposing the first running direction.

It is thus possible that the substrate or the transfer product is printed on depending on the two running directions.

Furthermore, it is also conceivable to provide a (working) method for a multi-application device, in particular according to one of claims 22 to 33, wherein the multi-application device comprises a multi-application module with a printing unit and a multifunctional element, and a cold transfer unit with a pressure roller and a counter-pressure roller, wherein a printing nip is formed between the printing unit and the multifunctional element, wherein, according to a first variant i), a substrate is guided along the multifunctional element to the printing nip in order to print on the substrate and is guided further to the counter-pressure roller and the pressure roller, with which a transfer product is pressed onto the substrate, or wherein, according to a second variant ii), the transfer product is guided along the multifunctional element to the printing nip in order to print on the transfer product and is guided further to the counter-pressure roller and pressure roller, with which the transfer product is pressed onto the substrate, and wherein the substrate and/or the transfer product, in variants i) and ii), are guided in each case in an opposing running direction, in particular in the multi-application module.

It is further also conceivable to provide a (working) method for a multi-application device, wherein the multi-application device comprises a multi-application module with a printing unit and a multifunctional element, and a cold transfer unit with a pressure roller and a counter-pressure roller, wherein a printing nip is formed between the printing unit and the multifunctional element, wherein, according to a third variant iii), a substrate is guided along the multifunctional element to the printing nip in order to print on the substrate and is guided further to the counter-pressure roller and the pressure roller. The third variant ili) is advantageously characterized in that no transfer product is clamped and the pressure roller is open. In other words, this means that only a substrate is printed on in this working method according to the third variant iii).

It is expedient if the multi-application module and/or the multi-application device and/or the working method for a multi-application device are used for applying a transfer ply of a transfer product to a substrate. It is also expedient if the multi-application module and/or the multi-application device and/or the working method for a multi-application device are used for printing on a substrate.

Furthermore, it is preferred if the multi-application device is a multi-application device for applying a transfer ply of a transfer product to a substrate. It is also advantageous if the multi-application device carries this out using a (working) method according to one of claims 34 to 46.

It is further preferably possible that the multi-application device is a multi-application device for printing on a substrate.

It is also conceivable that the (working) method for a multi-application device is a method or working method, in particular for operating a multi-application device or for carrying out three (operating) variants or production runs of a multi-application device. The three (operating) variants or production runs are preferably the first variant i) and the second variant ii) and the third variant iii).

A use of a multi-application module according to the invention for printing on a substrate or for printing on a transfer product, in particular with a UV-curable ink, is further conceivable.

Thus, it is advantageous that the printing on the substrate or on the transfer product is the printing of a UV-curable ink, in particular wherein the UV-curable ink acts as adhesive. The UV-curable ink can be transparent or translucent or opaque. The UV-curable ink can be colorless or dyed with dyes and/or with pigments. The colors of the dyes and/or the pigments can be visible in visible light and/or under UV light and/or under IR light.

Furthermore, a printing system is conceivable wherein the printing system further preferably comprises a multi-application module, preferably according to the invention, for printing on a substrate or a transfer product, with a printing unit and a multifunctional element, in particular wherein a printing nip is formed between the printing unit and the multifunctional element, and wherein the printing system further comprises the substrate and/or the transfer product. It is also advantageous here if the printing unit is designed such that it can print along two running directions in the printing nip.

Furthermore, a system is conceivable wherein the system further preferably comprises a multi-application module, preferably according to the invention, for printing on a substrate or a transfer product, with a printing unit and a multifunctional element, in particular wherein a printing nip is formed between the printing unit and the multifunctional element, wherein the system further comprises a cold transfer unit with a pressure roller and a counter-pressure roller, and wherein the system further also comprises the transfer product and/or the substrate. It is also advantageous here if the printing unit is designed such that it can print along two running directions in the printing nip.

Advantageously, the substrate or the transfer product has been or is guided in the printing system or in the system, as has already been explained above and is further stated below. In other words, all features which are disclosed in connection with the multi-application module, the multi-application device or the (working) method for a multi-application device are also transferable to the printing system and/or the system and thus are also regarded as disclosed as for the printing system and/or the system.

Further advantageous designs of the invention are described in the dependent claims.

The printing nip is preferably arranged between the circumferential edge of the multifunctional element and the printing unit. In particular, it is provided that the printing nip is formed between the printing unit and the surface lying opposite the printing unit. The surface lying opposite the printing unit can for example be the first multifunctional roller and/or the printing table and/or the at least one second multifunctional roller. It is preferably also possible that the printing nip is formed between the printing unit and the surface of the substrate and/or of the transfer product. In particular, it is provided here that the substrate and/or the transfer product is clamped along two second multifunctional rollers and/or along the first multifunctional roller and a second multifunctional roller on the side lying opposite the printing unit, with the result that the substrate and/or the transfer product forms the surface lying opposite the printing unit.

Thus, it is expedient if the printing nip, in particular the distance between the substrate or the transfer product guided on the circumferential edge of the multifunctional element and the printing unit, has a size of between 0.1 mm and 5 mm, preferably between 0.5 mm and 3 mm, in particular between 0.5 mm and 1 mm.

It is also preferred that ink is ejected from the printing unit perpendicularly, i.e. vertically, relative to the surface of the multifunctional element, in particular to the surface of the first multifunctional roller and/or to the flat printing surface and/or to the flat surface area of the printing table. For this it is advantageous in particular if the surface of the printing unit is arranged with the “nozzles” parallel or substantially parallel in each case to the surface of the multifunctional element lying opposite the printing unit or to the tangent to the surface of the multifunctional element, in particular the first multifunctional roller and/or the at least one second multifunctional roller and/or the printing table.

This surface lying opposite the printing unit is preferably arranged horizontally and in particular formed as flat as possible, i.e. has only a slight to no curvature in one or more directions. In the case of the surface of the first multifunctional roller, the surface should be cylindrically curved in only one direction and this curvature should be as slight as possible, for example due to as large as possible a diameter of the first multifunctional roller. Any undesired distortions of the printed image on a curved surface can be at least partially compensated for by a digital or electronic predistortion or precompensation of the digital print data, with the result that a printed image that has as little distortion as possible forms on the curved surface.

It is further expedient if the multi-application module further has two winding rollers for receiving the transfer product.

It is possible here for example that a first of the two winding rollers has been or is driven clockwise and/or a second of the two winding rollers has been or is driven counterclockwise.

However, it is also possible that a first of the two winding rollers and a second of the two winding rollers are driven in each case clockwise or counterclockwise.

In other words, it is also possible that the two winding rollers have the same or opposing rotational directions.

Thus, it is expedient that the transfer product is unwound from a first of two winding rollers and is wound onto a second of two winding rollers, in particular wherein the first of the two winding rollers and the second of the two winding rollers have the same or opposing rotational directions. It is further expedient that the transfer product is unwound from a first of two winding rollers and is wound onto a second of two winding rollers, in particular wherein the first of the two winding rollers is driven counterclockwise and/or the second of the two winding rollers is driven clockwise.

It is thus possible that, in variants i) and ii), the first of the two winding rollers is driven or rotated clockwise and/or the second of the two winding rollers is driven or rotated counterclockwise.

The position and drive direction of the winding rollers are preferably also dependent on the running direction of the substrate and/or of the transfer product. Assuming that the running direction of the substrate and/or of the transfer product in the printing nip in the case of the substrate is opposite to the running direction of the transfer product, assuming that the transfer ply on the transfer product has to be printed on, assuming that it is wound on the inside of the transfer product roller and then has to point in the direction of the printing unit in the printing nip, there are many variables which influence the rotational direction of the first winding roller, in particular the unwinding roller. However, the rotational direction of the second winding roller, in particular the winding-up roller, is not dependent on this and can in principle rotate in both directions and in both cases fulfil the function of winding up the carrier ply.

The transfer product is hereby provided in particular and, after at least a partial area of the transfer ply has been applied to the substrate, the carrier ply that has been separated from the transfer ply is wound up again.

It is possible that the multi-application module further has a clamping system for clamping the transfer product, wherein the clamping system has one or more of the following elements, selected individually or in combination from: dancer roller, controlled dancer roller, measuring roller, friction shaft. A transport of the transfer product under tension is hereby achieved.

It is advantageously provided that the first multifunctional roller in combination with a second multifunctional roller and/or the first multifunctional roller in combination with two second multifunctional rollers and/or two second multifunctional rollers are arranged such that the substrate or the transfer product can be guided via the first multifunctional roller and/or the at least one second multifunctional roller and thereby forms a flat printing surface, in particular can be guided such that the substrate and/or the transfer product forms a flat printing surface.

It is also possible that the flat printing surface is arranged perpendicular to the printing unit and/or forms a surface area with a size of between 250 mm² and 1,000,000 mm², preferably between 1000 mm² and 200,000 mm².

It is also advantageous that the printing table is arranged such that the substrate or the transfer product can be guided over the printing table.

In particular, a flat printing surface is hereby generated, which makes an exact and high-quality printing result possible.

The printing table preferably forms a flat surface area, in particular of between 250 mm² and 1,000,000 mm², preferably between 1000 mm² and 200,000 mm². It is also possible that the printing table has a length in the feed direction of the substrate and/or of the transfer product of between 5 mm and 500 mm, in particular between mm and 100 mm, and/or a width transverse with respect to the feed direction of the substrate and/or of the transfer product of between 50 mm and 2000 mm, in particular between 100 mm and 1000 mm.

Furthermore, it is preferred if the printing table is arranged perpendicular to the printing unit. It is furthermore also possible that the printing table or the flat printing surface is arranged such that the printing unit ejects ink perpendicular to the printing table or to the flat printing surface.

It is also useful if the distance between the printing unit and the printing table and/or the flat printing surface, in particular the flat printing surface of the substrate or the transfer product, is between 0.1 mm and 5 mm, preferably between 0.5 mm and 3 mm.

It is also possible that the printing table has air outlets for generating an air cushion, in particular an air cushion between the printing table and the substrate or the transfer product. This makes a particularly smooth movement of the substrate or the transfer product over the table possible, as a result of which the printing accuracy and the print quality are further increased. This also prevents the rear side of the substrate from being scratched.

It is also advantageous if a UV-curable ink can be printed or is printed by means of the printing unit.

Furthermore, it is useful that the multi-application module further has at least one UV precuring light source, preferably wherein in each case one UV precuring light source is arranged on each side of the printing unit, in particular along the two running directions. It is alternatively also possible that the at least one UV precuring light source is remountable, in particular reconnectable, on each side of the printing unit, in particular along the two running directions. A fixing of the print, in particular the UV-curable ink, is hereby achieved immediately after the printing on the substrate or the transfer product, in particular since an irradiation with UV light can be effected in both running directions.

In other words, the at least one UV precuring light source is arranged downstream along the respective running direction with respect to the printing device in relation to the multifunctional element such that a fixing can be effected immediately after the printing.

The at least one UV precuring light source is preferably a UV LED, which in particular generates light from the wavelength range between 100 nm and 420 nm, preferably between 280 nm and 405 nm, further preferably between 280 nm 380 nm, still further preferably between 365 nm and 380 nm.

The distance between the UV precuring light source and the, in particular printed, substrate or transfer product, is further preferably between 1 mm and 50 mm, preferably between 3 mm and 20 mm.

It is also expedient if the distance between the UV precuring light source and the printing unit or the printing table is between 10 mm and 500 mm, preferably between 30 mm and 100 mm. The UV precuring light source can thereby be positioned as close as possible next to the printing unit, and a shielding of the printing unit from the UV radiation can thus nevertheless be made possible.

The at least one UV precuring light source preferably generates an irradiance of between 0 W/cm² and 10 W/cm², preferably between 0.5 W/cm² and 7.5 W/cm², further preferably between 2 W/cm² and 5 W/cm². An adequate fixing of the printing is hereby guaranteed, with the result that a high print quality is achieved. The exact chosen irradiance is in particular dependent on the speed of the moving substrate and/or the moving transfer product, depending on what is being printed on, in order in each case to be able to introduce approximately the same amount of energy into the material in the case of different speeds.

It is expedient if the first multifunctional roller has a diameter of between 5 cm and 100 cm, in particular between 10 cm and 50 cm.

Furthermore, it is expedient if the at least one second multifunctional roller has a diameter of between 1 cm and 20 cm, in particular between 3 cm and 10 cm.

The surface of the first multifunctional roller and/or of the at least one second multifunctional roller advantageously has a surface structure generated by a surface finishing process. The surface structures can be generated in convex and/or concave form by one or more surface finishing processes, selected individually or in combination from: irradiating, abrasive blasting, turning, stripping, knurling, fluting, grinding, grooving.

It is also advantageous if the first multifunctional roller and/or the at least one second multifunctional roller has an anti-slip coating and/or a traction coating, in particular with a layer thickness of between 30 μm and 3 mm, preferably between 50 μm and 100 μm. It is thus possible that a rubberization is used as anti-slip coating, for example. The anti-slip coating can be implemented by a structuring in the sense of an introduced relief and/or by means of applying an additional material layer, in particular a rubber coating for achieving an improved “grip” or slip resistance for the transfer product and/or the substrate on the first multifunctional roller and/or the at least one second multifunctional roller.

In particular, a more reliable transport of the substrate or of the transfer product on the first multifunctional roller and/or the at least one second multifunctional roller is hereby achieved, wherein in particular the transported web, in particular the substrate or the transfer product, is prevented from slipping through.

The first multifunctional roller and/or the at least one second multifunctional roller is advantageously driven by the substrate or the transfer product wrapping at least partially around it, in particular wherein a constant drive is also achieved or guaranteed due to the surface roughness or anti-slip coating of the multifunctional roller and the accompanying slip resistant surface of the multifunctional roller.

It is thus advantageous if the substrate or the transfer product wraps at least partially around the first multifunctional roller and/or the at least one second multifunctional roller, in particular for stable transport in the printing nip.

It is further preferred if the first multifunctional roller and/or the at least one second multifunctional roller comprises an encoder for detecting and/or controlling the rotational speed of the first multifunctional roller and/or the at least one second multifunctional roller and/or the printing procedure. In particular, an exact synchronization of the rotational speed of the first multifunctional roller and/or of the at least one second multifunctional roller with the printing unit is hereby achieved, with the result that a register-accurate printing is made possible.

By registered or register, or registration accurate or register accurate, or registration accuracy or register accuracy, is meant a positional accuracy of two or more layers relative to each other. The register accuracy is to vary within a predefined tolerance, which is to be as small as possible. At the same time, the register accuracy of several elements and/or layers relative to each other is an important feature for increasing the process reliability. The positionally accurate positioning can be effected in particular by means of sensorily, preferably optically, detectable registration marks or register marks. These registration marks or register marks can either represent special separate elements or areas or layers or themselves be part of the elements or areas or layers to be positioned.

It is thus possible that, in the first variant i), the substrate comprises at least one element and/or at least one layer on which the printing is positioned on the substrate as a further layer in register with this at least one element and/or with the at least one layer. The position of the at least one element and/or the at least one layer on the substrate or on the transfer product is preferably recognized upstream of the printing procedure with an optically detectable registration mark or register mark. Via the detection of the rotational speed of the multifunctional roller it can thus be determined when the at least one element and/or the at least one layer on the substrate or on the transfer product reaches the printing unit and the printing is positioned on the substrate in register with it.

In particular, it is provided that the multi-application module comprises at least one detection unit, which detects the position of at least one element and/or at least one layer on the substrate and/or the transfer product, in particular detects it by means of a registration mark or register mark, wherein the detection unit is connected to a control device, which controls the printing unit on the basis of the position data detected by the detection unit such that the printing on the substrate and/or the transfer product is effected in register with the at least one element and/or the at least one layer.

It is also possible that, in the second variant ii), the substrate comprises at least one element and/or at least one layer, wherein printing applied to the transfer product is positioned relative thereto. The at least one element and/or the at least one layer on the substrate and the printing on the transfer product can overlap completely or partially or not at all. The position of the at least one element and/or the at least one layer on the substrate is preferably recognized with an optically detectable registration mark or register mark and thus the start of the printing procedure is controlled such that the printing is effected on the transfer product such that, after the transport to the press nip between counter-pressure roller and pressure roller, the printing is pressed in register with the at least one element and/or the at least one layer on the substrate.

However, it is also possible that, in the first variant i), the substrate comprises at least one element and/or at least one layer, in register with which the printing is positioned as a further layer. The position of the at least one element and/or the at least one layer on the substrate is preferably recognized upstream of the printing with an optically detectable registration mark. Via the detection of the rotational speed of the multifunctional roller it can thus be determined when the element or the layer on the substrate reaches the printing unit and the printing is positioned in register with it.

Furthermore, it is also possible that the at least one element and/or the at least one layer on the transfer product is pressed, in the press nip between counter-pressure roller and pressure roller, in register with the at least one element and/or with the at least one layer and/or with the printing on the substrate. For this it is expedient if the position of the at least one element and/or the at least one layer both on the substrate and on the transfer product is recognized with an optically detectable registration mark or register mark allocated in each case to the transfer product and the substrate, and the positioning is effected via the stretching of the transfer product, with the result that, after the transport of the transfer product to the press nip between counter-pressure roller and pressure roller, the at least one element or the at least one layer on the transfer product is pressed onto the at least one element and/or the at least one layer on the substrate in register. This results in a register between the at least one element or the at least one layer on the substrate, the printing and the transfer product.

In particular, it is provided that the cold stamping unit comprises at least one detection unit, which detects the position of at least one element and/or at least one layer on the substrate and/or the transfer product, in particular detects it by means of a registration mark or register mark, and the positioning is effected via the stretching of the transfer product, with the result that, after the transport of the transfer product to the press nip, the pressure roller presses the at least one element and/or the at least one layer on the transfer product onto the at least one element and/or the at least one layer on the substrate in register.

Furthermore, it is also possible that, in the second variant ii), the substrate comprises at least one element and/or at least one layer, in register with which at least one element and/or at least one layer on the transfer product is pressed, in the press nip between counter-pressure roller and pressure roller, onto the at least one element or the at least one layer on the substrate. For this it is useful if the printing is positioned in register with the at least one element and/or the at least one layer on the transfer product. The position of the at least one element and/or the at least one layer both on the substrate and on the transfer product is preferably recognized with an optically detectable registration mark or register mark, allocated in each case to the transfer product and the substrate, on the transfer product and on the substrate and is positioned via the stretching of the transfer product. The at least one element and/or the at least one layer on the substrate and the transfer product can in each case overlap completely or partially or not at all. This results in a register between the at least one element or the at least one layer on the substrate, the printing and the transfer product.

For the accurate positioning of the substrate and the transfer product relative to each other it is preferably provided that the at least one detection unit of the multi-application module and the at least one detection unit of the cold stamping unit are connected to a common control device, which controls the rotational speed of the rollers and/or the printing unit on the basis of the detected register marks or position marks such that the at least one elements and/or the at least one layer on the substrate is arranged in register with the printing on the transfer product.

In particular, it is useful if, for the stretching of the transfer product, in the first variant i), for positioning at least one element and/or at least one layer on the transfer product in register with the at least one element and/or the at least one layer on the substrate, the clamping system is used after the film is unwound.

It is also possible that the multi-application device has a transfer product transport system with a clamping system for the controlled transport of material, wherein the transfer product transport system controls the register-accurate positioning in the press nip of the at least one element and/or the at least one layer on the transfer product and the at least one element and/or the at least one layer on the substrate via the stretching of the transfer product by means of the clamping system. The transfer product transport system preferably comprises at least one driven roller influencing the transport speed of the transfer product and a detection unit, in particular an optical sensor, for recognizing the position of the at least one element and/or the at least one layer on the transfer product by means of an optically detectable registration mark or register mark applied to the transfer product. Such a driven roller can have one or more of the following elements, selected individually or in combination from: roller with opposing pressure roller, roller with at least one or more segmented pressure roller, vacuum roller.

It can preferably also be provided that the multi-application device has a transfer product transport system for the controlled transport of material, wherein the transfer product transport system controls the register-accurate positioning in the press nip of the at least one element and/or the at least one layer on the transfer product and the at least one element and/or the at least one layer on the substrate via the stretching of the transfer product by means of a driven vacuum roller, in particular wherein the transfer product is arranged with its unprinted side on the vacuum roller, with the result that the transfer product undergoes stretching without touching the already printed side of the transfer product.

Alternatively, the stretching of the transfer product can also be made possible via at least one drive on the multifunctional roller, wherein the stretching of the transfer product in the area between the multifunctional roller and the press nip can be influenced via the speed of the transfer product transport at the multifunctional roller relative to the speed of the substrate transport in the press nip between counter-pressure roller and pressure roller, and thus the positioning of the at least one element and/or the at least one layer on the transfer product in register with the at least one element and/or the at least one layer on the substrate is controlled.

It is possible that the printing unit comprises at least one inkjet printhead.

The printing unit preferably is or comprises a UV inkjet printbar, in particular with one or more inkjet printheads.

The UV inkjet printbar expediently has a printing width transverse to the feed direction of the substrate and/or of the transfer product of between 50 mm and 2000 mm, in particular between 100 mm and 1000 mm.

It is possible here that the UV inkjet printbar and/or the one or more inkjet printheads has a resolution of from 300 to 1200 npi (nozzles per inch). This resolution is seen transversely with respect to the feed direction of the transfer product and/or of the substrate and is in particular dependent on design. It is also possible that the UV inkjet printbar and/or the one or more inkjet printheads has a resolution of from 300 to 2400 dpi (dots per inch). This resolution is seen in the feed direction of the transfer product and/or of the substrate and is in particular electronically controllable or modifiable, preferably in order to alter the quantity of ink applied.

Furthermore, it is possible that the UV inkjet printbar and/or the one or more inkjet printheads has a maximum printing speed of 300 m/min, preferably a maximum printing speed of 200 m/min.

It is also advantageous if the printing unit and/or the UV inkjet printbar has at least two rows of printheads.

It is further advantageous if the printing unit has at least two ink receiving devices for receiving at least two different inks.

It is hereby achieved in particular that in each case the optimum ink is immediately available both for the printing on the substrate and for the printing on the transfer product, with the result that an automatic ink change is made possible in the case of the use of a single printing unit.

In between ink changes it is advantageous to provide a cleaning procedure, which clears the ink supply system and the printhead of residues of the first ink before the second ink is supplied. In particular, since the substrate and the transfer product usually have different physical properties, such as for example absorbency or surface finish, the most suitable ink in each case can be used immediately without having to refill the printing unit first.

The printing unit is preferably configured by means of a digital program, with the result that it can print along the two running directions.

In other words, it is useful if the printing unit is configured by means of a digital program such that it can print both according to the first variant i) and according to the second variant ii).

Alternatively or additionally, the printing unit can be implemented such that it can be rotated by 180°, in particular mechanically, about an axis perpendicular to the running direction or parallel to the normal of the running direction and/or parallel to the normal of the printing surface.

It is preferred if the multi-application module further has one or more deflection rollers and/or one or more guide rollers.

Preferably, the substrate or the transfer product can be guided by means of the first multifunctional roller and/or the at least one second multifunctional roller, and/or the first multifunctional roller and/or the at least one second multifunctional roller is formed for guiding the substrate or the transfer product.

It is thus possible that, in the printing nip, the substrate guided on the first multifunctional roller and/or the at least one second multifunctional roller or the transfer product guided on the first multifunctional roller and/or the at least one second multifunctional roller can be printed along the two, preferably opposing, running directions by means of the printing unit, wherein the rotational directions of the first multifunctional roller and/or of the at least one second multifunctional roller are further preferably opposing during the guiding of the substrate and the transfer product.

It is further possible that, if the first multifunctional roller and/or the at least one second multifunctional roller is rotated in a first rotational direction, the substrate guided on the first multifunctional roller and/or the at least one second multifunctional roller can be printed on in the printing nip, in particular in a first running direction, or that, if the first multifunctional roller and/or the at least one second multifunctional roller is rotated in a second rotational direction, opposing the first rotational direction, the transfer product guided on the first multifunctional roller and/or the at least one second multifunctional roller can be printed on in the printing nip, in particular in a second running direction, opposing the first direction.

It is thus expedient if, according to a first variant i), the substrate can be guided along the multifunctional roller, in particular in the case of rotation in a first rotational direction, to the printing nip (or in the direction of the printing nip) in order to print on the substrate or that, according to a second variant ii), the transfer product can be guided along the multifunctional roller, in particular in the case of rotation in a second rotational direction, opposing the first rotational direction, to the printing nip (or in the direction of the printing nip) in order to print on the transfer product, preferably wherein the substrate or the transfer product can be printed on in the same printing nip.

It is advantageous that the multi-application module has a changeable substrate path and/or transfer product path.

It is also advantageous if both variants i) and ii) can be chosen or implemented in the same multi-application device or are implemented by the same multi-application device.

It is thus possible that both the substrate and the transfer product can be printed on in the printing nip by means of the multi-application module.

The printing on the substrate or on the transfer product is advantageously effected with the same printing unit in the same printing nip, in particular wherein the substrate or the transfer product is guided on the same first multifunctional roller and/or at least one second multifunctional roller.

In other words, it is advantageous that the printing on the substrate or on the transfer product is effected in the same multi-application module, in particular wherein the running directions and/or running paths of the substrate and/or the transfer product differ or are opposing.

Thus, it is also expedient if the printing on the substrate or on the transfer product is effected in the same multi-application module, wherein the substrate running direction and the transfer product running direction or transport directions differ, in particular are opposing.

It is further also preferred that the printing on the substrate or on the transfer product is effected in the same printing nip and/or that the pressing of the transfer product onto the substrate is effected with the same counter-pressure roller and the same pressure roller.

Further preferred designs of the multi-application device are described in particular, among other things, in the following:

The pressure roller is preferably formed with a coating of rubber or silicone with a hardness of between 25 Shore A and 100 Shore A, preferably between 50 Shore A and 90 Shore A. It is further expedient if the coating has a thickness of between 1 mm and 20 mm, in particular between 1 mm and 5 mm.

It is further possible that the counter-pressure roller is coated with hard chromium.

The surface of the counter-pressure roller is advantageously made of a material with an abrasion resistance of from 40 Rockwell C to 80 Rockwell C, in particular from 60 Rockwell C to 70 Rockwell C.

It is also possible that the counter-pressure roller is cooled.

Furthermore, it is expedient if the pressure roller has a diameter of between 1 cm and 50 cm, in particular between 5 cm and 20 cm. It is further expedient if the counter-pressure roller has a diameter of between 5 cm and 70 cm, in particular between 10 and 50 cm.

The counter-pressure roller and/or the pressure roller is preferably driven.

It is advantageous if the cold transfer unit further comprises at least one UV final curing light source, in particular wherein the UV final curing light source is arranged after the pressure roller, preferably in the running direction of the substrate and/or of the transfer product. A firm bond between the transfer ply and the substrate is hereby achieved before the carrier ply is removed from the transfer ply.

It is possible here that the at least one UV final curing light source is arranged between 5 cm and 20 cm, in particular between 5 cm and 10 cm, downstream of or after the pressure roller and/or the counter-pressure roller, in particular in the conveying direction of the substrate and/or of the transfer product.

The cold transfer unit preferably further comprises a detachment roller or a detachment blade, in particular for detaching a carrier ply from a transfer ply of the transfer product.

It is useful here if the detachment roller or the detachment blade, in particular in the conveying direction of the substrate and/or of the transfer product, is arranged between 5 cm and 50 cm, in particular between 5 cm and 20 cm, downstream in the conveying direction of the substrate and/or of the transfer product or after the at least one UV final curing light source.

It is also useful if the detachment roller has a diameter of between 0.5 cm and 10 cm.

Furthermore, it is possible that the cold transfer unit further comprises at least one further UV final curing light source, in particular wherein the further UV final curing light source is arranged downstream of or after the detachment roller or the detachment blade, in particular in the running direction of the substrate.

It is useful here if the at least one further UV final curing light source is arranged between 5 cm and 50 cm, in particular between 5 cm and 20 cm, downstream of or after the detachment roller or the detachment blade, in particular in the conveying direction of the substrate.

The at least one UV final curing light source and/or the at least one further UV final curing light source is preferably a UV LED, which in particular generates light from the wavelength range between 100 nm and 420 nm, preferably between 280 nm and 405 nm, further preferably between 280 nm 380 nm, still further preferably between 365 nm and 380 nm.

The at least UV final curing light source and/or the at least one further UV final curing light source preferably generates an irradiance of between 5 W/cm² and 50 W/cm², preferably between 15 W/cm² and 25 W/cm². The exact chosen irradiance is in particular dependent on the speed of the moving substrate and/or the moving transfer product, depending on what is being printed on, in order in each case to be able to introduce approximately the same amount of energy into the material in the case of different speeds.

It is particularly preferred that one or more component parts are provided, in particular for adapting a feeding angle α of the transfer product into a press nip formed out of pressure roller and counter-pressure roller, selected from the group: pressure roller, at least one UV final curing light source, detachment roller or detachment blade, at least one further UV final curing light source, are pivotable about the counter-pressure roller.

The feeding angle α is advantageously formed by two arms, wherein the first arm represents a half-line the origin of which is the center of the press nip and which is tangent to the counter-pressure roller or the pressure roller, and the second arm represents a half-line the origin of which is the point at which the transfer product and/or the substrate first touches the surface of the counter-pressure roller or the pressure roller and which is tangent to the counter-pressure roller or the pressure roller.

The press nip is preferably the gap which represents the shortest distance between the peripheral surfaces of the counter-pressure roller and the pressure roller.

The feeding angle α is preferably at least 5°, particularly preferably at least 10°. In particular, the feeding angle α has this minimum value when the diameter of the respective roller is between 5 cm and 50 cm.

It is also particularly preferred that the cold transfer unit is displaceable relative to the multi-application module, in particular for adapting a feeding angle α of the transfer product into a press nip formed out of pressure roller and counter-pressure roller.

In particular, it is advantageous if one or more component parts selected from the group: pressure roller, at least one UV final curing light source, detachment roller or detachment blade, at least one further UV final curing light source, are pivotable, in particular about the counter-pressure roller, such that the respective feeding angle α of the transfer product and/or of the substrate into a press nip formed out of pressure roller and counter-pressure roller can be set for the first variant i) and the second variant ii), in particular in order to comply with the minimum value of the feeding angle α.

It is also further advantageous if the cold transfer unit is displaceable relative to the multi-application module such that the respective feeding angle α of the transfer product and/or of the substrate into a press nip formed out of pressure roller and counter-pressure roller can be set for the first variant i) and the second variant ii), in particular in order to comply with the minimum value of the feeding angle α.

A flexible adaptation of the feeding angle α, in particular depending on the variants i) or ii), is hereby made possible. Thus, the feeding angle α can in particular be adapted or rotated between the first variant i) and the second variant ii). In particular, the substrate can hereby already be guided via the counter-pressure roller before the pressure roller, whereas the transfer product is supplied to the press nip via the pressure roller. A high-quality stamping result is hereby achieved in particular.

It is further expedient if an adapter, which in particular makes a mechanically stable fastening of the multi-application module to the cold transfer unit possible, is arranged between the multi-application module and the cold transfer unit.

It is also preferred if the cold transfer unit or the multi-application device further has one or more deflection rollers and/or one or more guide rollers.

It is also possible that the cold transfer unit is designed as an extension module. In particular, the multi-application device can thus be inserted into a processing machine, such as in a flexographic printing machine, with an already present printing mechanism, here a flexographic printing mechanism, which fulfils the function of the cold transfer unit, in particular with pressure roller and UV final curing light source.

The pressure roller and/or the counter-pressure roller is advantageously driven, in particular such that the counter-pressure roller rotates clockwise or counterclockwise.

For example, it is possible that the counter-pressure roller rotates clockwise. In this case, for example, the first multifunctional roller and/or the at least one second multifunctional roller likewise rotates clockwise in order to print on the substrate, whereas the first multifunctional roller and/or the at least one second multifunctional roller then rotates counterclockwise in order to print on the transfer product.

Of the two winding rollers, for example a first, thus the unwinding roller, accordingly rotates counterclockwise for unwinding the transfer product and a second, thus the winding-up roller, rotates clockwise for winding up the transfer product, or at least the carrier ply of the transfer product. It is also possible analogously also to reverse all rotational directions.

It is further possible both for one and for several transfer product rolls to be located on the winding rollers. The use of several transfer product rolls is advantageous in particular if only an application to the substrate in tracks is to take place. One transfer product roll can be assigned to one track on the substrate to which an application is to be effected. The individual transfer product rolls can be arranged at a distance from the neighboring transfer product roll. Differently formed transfer product rolls, in particular with different colors, elements or layers, can also be used.

In other words this means that, for the first variant i), a substrate is guided along a multifunctional element to a printing nip formed between a printing unit and the multifunctional element in order to print on the substrate and is guided further to the one counter-pressure roller and a pressure roller, with which several transfer products are pressed onto the substrate. By several is meant at least two transfer products.

For the second variant ii) this preferably means that several transfer products are guided along the multifunctional element to the printing nip formed between the printing unit and the multifunctional element in order to print on the several transfer products and are guided further to the counter-pressure roller and the pressure roller, with which the several transfer products are pressed onto the substrate. Here too, by several is meant at least two transfer products.

Further preferred designs of the (working) method for a multi-application device are described in particular, among other things, in the following:

It is further advantageous if the (working) method for the multi-application device further comprises the following step:
printing on the substrate or the transfer product in the printing nip, in particular in the same printing nip, by means of a printing unit, in particular by means of the same printing unit.

It is preferably provided that the multifunctional element has a first multifunctional roller and/or at least one second multifunctional roller and/or a printing table.

It is also possible that the first multifunctional roller and/or the at least one second multifunctional roller is mounted rotatable in two opposing rotational directions, in particular wherein printing can be effected in the printing nip, preferably by the printing unit, along the two running directions which are predefined by the two opposing rotational directions.

Furthermore, it is useful that printing can be effected in the printing nip, preferably by the printing unit, along two running directions which are predefined by the two opposing rotational directions, further preferably the first and second rotational direction, of the first multifunctional roller and/or the at least one second multifunctional roller.

The substrate or the transfer product is preferably printed on in each case on the side of the substrate or of the transfer product facing away from the surface of the first multifunctional roller and/or of the at least one second multifunctional roller and/or of the printing table.

In the first variant i), the first multifunctional roller and/or the at least one second multifunctional roller is preferably rotated in a first rotational direction and, in variant ii), the first multifunctional roller and/or the at least one second multifunctional roller is rotated in a second rotational direction, opposing the first rotational direction.

In the first variant i) the counter-pressure roller is further preferably rotated in a rotational direction corresponding to the running direction of the substrate in the multifunctional element and in the second variant ii) the counter-pressure roller is rotated in an opposing rotational direction corresponding to the running direction of the transfer product in the multifunctional element.

It is thus possible that in the first variant i) the running direction of the multifunctional element runs towards the right, in particular the first multifunctional roller and/or the at least one second multifunctional roller is rotated clockwise, and that in variant ii) the running direction of the multifunctional element runs towards the left, in particular the first multifunctional roller and/or the at least one second multifunctional roller is rotated counterclockwise. It is further possible here that in the first variant i) the counter-pressure roller is likewise rotated clockwise and that in the second variant ii) the counter-pressure roller is also rotated clockwise. It is also possible to reverse all rotational directions indicated.

It is also possible that, in variant i), the substrate is guided along the first multifunctional roller and/or the at least one second multifunctional roller and/or the printing table to the printing nip in order to print on the substrate and is guided further to the press nip formed out of counter-pressure roller and pressure roller, wherein the transfer product is guided from a first of two winding rollers to the press nip formed out of counter-pressure roller and pressure roller and/or that, in variant ii), the transfer product is guided from a first of two winding rollers along the first multifunctional roller and/or the at least one second multifunctional roller and/or the printing table to the printing nip in order to print on the transfer product, wherein the substrate is guided along the counter-pressure roller to the press nip formed out of counter-pressure roller and pressure roller.

The features, effects and advantages described in connection with the multi-application module can analogously also be transferred to the multi-application device, the (working) method for a multi-application device, the use of a multi-application module, the printing system and the system, and thus are regarded as also disclosed. The same applies in the opposite direction: features, effects and advantages which are described in connection with the multi-application device, the (working) method for a multi-application device, the use of a multi-application module, the printing system and the system are also transferable to multi-application module and are regarded as also disclosed.

Embodiment examples of the invention are explained below by way of example with reference to the accompanying figures, which are not to scale.

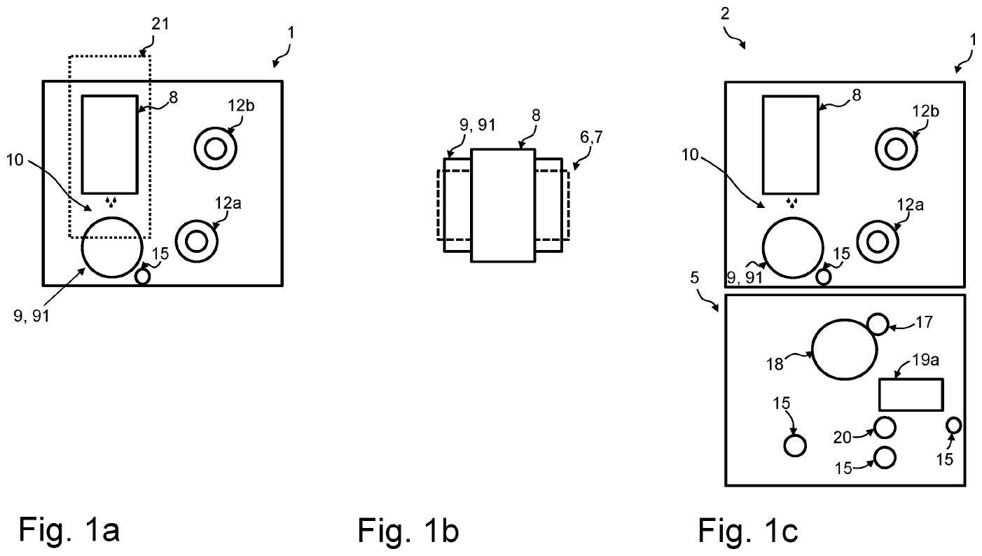

FIG. 1a shows, schematically, a sectional representation of a multi-application module

FIG. 1b shows, schematically, a top view of a section of FIG. 1a

FIG. 1c shows, schematically, a sectional representation of a multi-application device

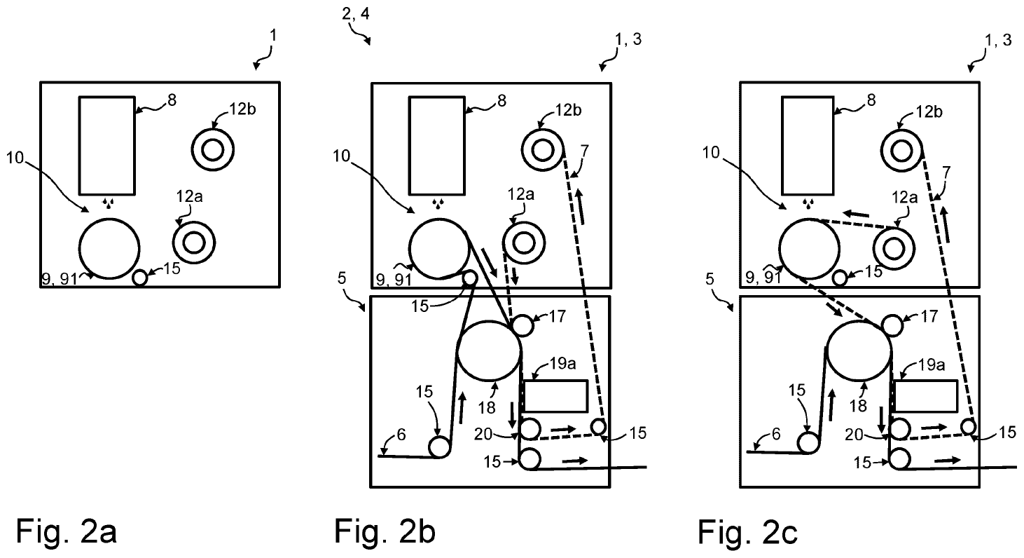

FIGS. 2a to 2c show, schematically, a sectional representation of a multi-application module and a sectional representation of a system

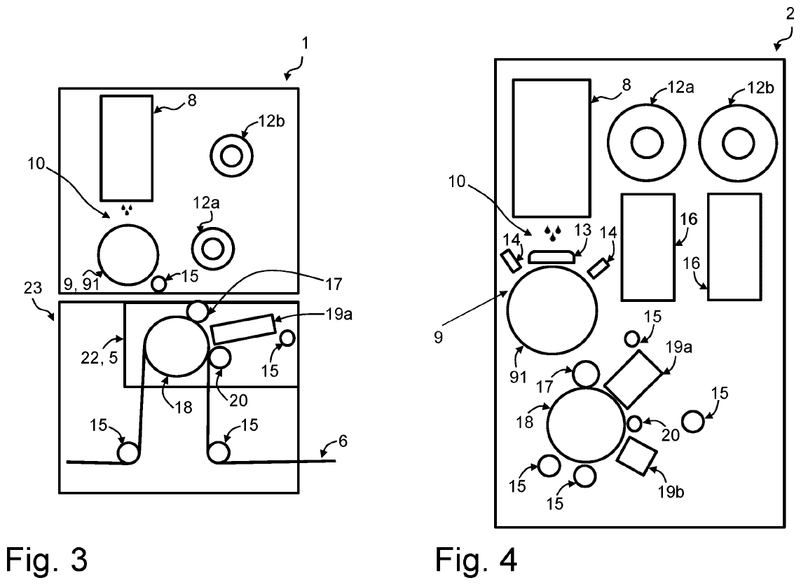

FIG. 3 shows, schematically, a sectional representation of a multi-application module and a cold transfer unit

FIG. 4 shows, schematically, a sectional representation of a multi-application device

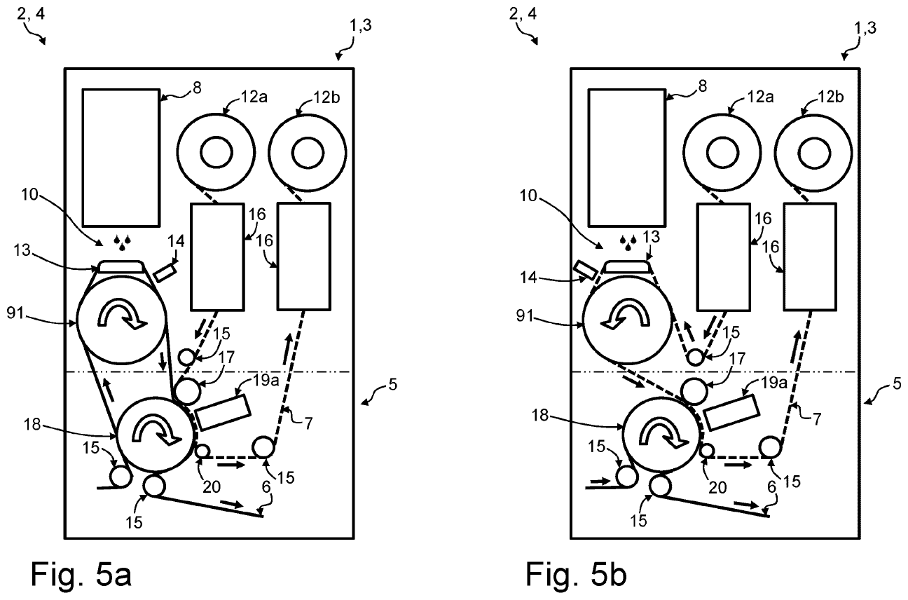

FIGS. 5a and 5b shows, schematically, a sectional representation of a system

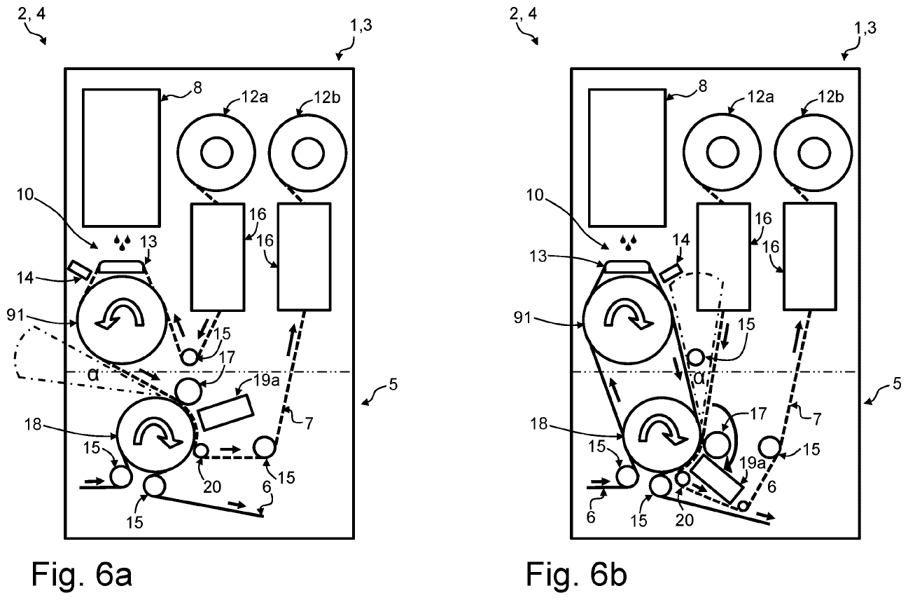

FIGS. 6a and 6b shows, schematically, a sectional representation of a system

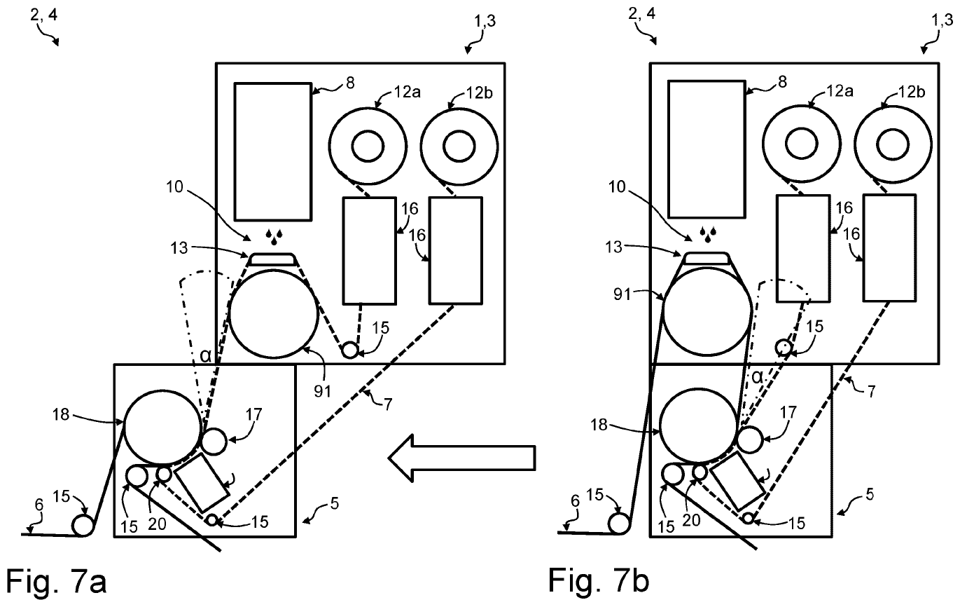

FIGS. 7a and 7b shows, schematically, a sectional representation of a system

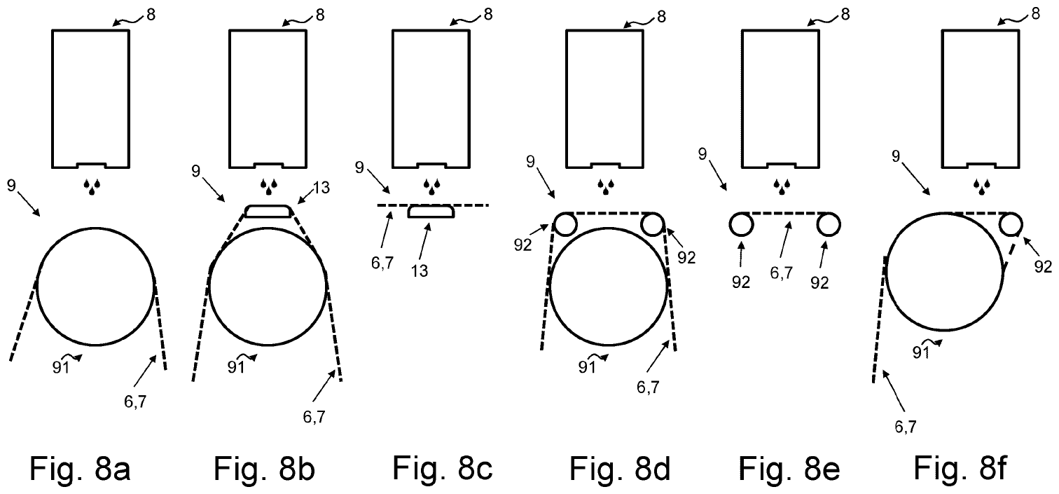

FIGS. 8a to 8f show, in each case schematically, a sectional representation of a multifunctional element of the multi-application module

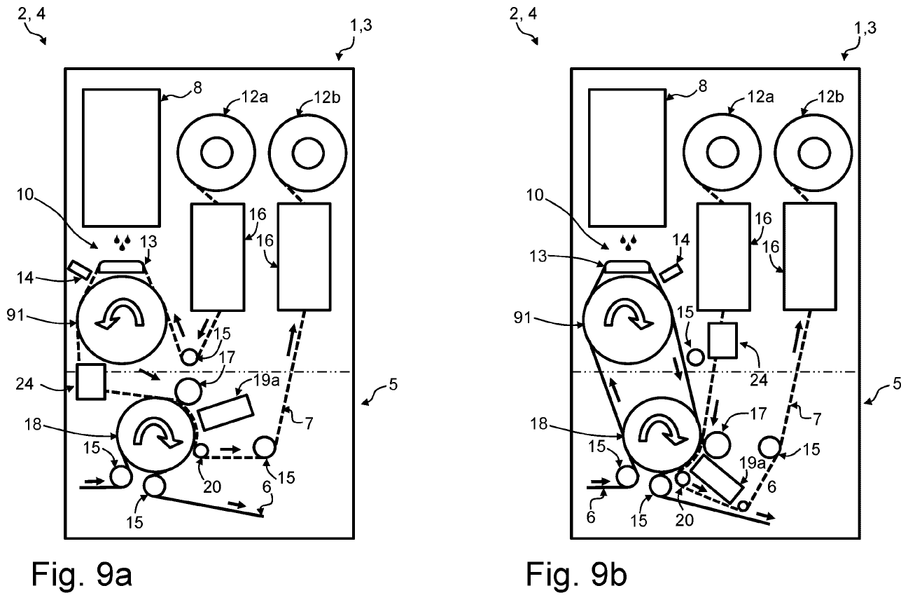

FIGS. 9a and 9b shows, schematically, a sectional representation of a system

FIG. 1a shows, schematically, a sectional representation of a multi-application module 1.

As shown in FIG. 1a, the multi-application module 1 comprises a printing unit 8 and a multifunctional element 9, wherein a printing nip 10 is formed between the printing unit 8 and the multifunctional element 9. The multifunctional element 9 comprises a first multifunctional roller 91.

In order to make it possible to print on both a substrate 6 or a transfer product 7 by means of the multi-application module 1, the first multifunctional roller 91 is here mounted rotatable in two opposing rotational directions. The printing unit 8 is further designed such that it can print along two running directions, which are predefined by the two opposing rotational directions, in the printing nip 10.

The multi-application module 1, shown in FIG. 1a, for printing on a substrate 6 or a transfer product 7 thus makes two running directions possible, which are predefined by two opposing rotational directions of the first multifunctional roller 91, and makes it possible to print on the substrate 6 in a first running direction of the two running directions and to print on the transfer product 7 in a second running direction of the two running directions.

It is thus possible that the substrate 6 or the transfer product 7 is printed on depending on the rotational direction of the first multifunctional roller 91, or the two running directions.

As shown in FIG. 1a, the printing nip is preferably arranged between the circumferential edge of the first multifunctional roller 91 and the printing unit 8. Furthermore, it is preferred if the printing unit 8 is arranged perpendicular to the first multifunctional roller 91.

It is also expedient if the printing nip 10, in particular the distance between the circumferential edge of the first multifunctional roller 91 and the underside of the printing unit 8, has a size of between 0.1 mm and 5 mm, preferably between 0.5 mm and 3 mm, in particular between 0.5 mm and 1 mm.

The first multifunctional roller 91, shown in FIG. 1a, has a diameter of between 5 cm and 100 cm, in particular between 10 cm and 50 cm, for example.

The surface of the first multifunctional roller 91 and/or of the at least one second multifunctional roller 92 can have a surface structure generated by a surface finishing process or be coated with an anti-slip coating, in particular in order to make the surface slip resistant, with the result that the first multifunctional roller 91 and/or the at least one second multifunctional roller 92 can be driven by the medium to be printed on, thus in particular the substrate 6 or the transfer product 7. Here, the layer thickness of the anti-slip coating is preferably between 30 μm and 3 mm, further preferably between 50 μm and 100 μm. A rubberization is used as anti-slip coating, for example. It is preferred that the first multifunctional roller 91 further comprises an encoder for detecting and/or controlling the rotational speed of the first multifunctional roller 91 and/or for controlling the printing procedure. In particular, an exact synchronization of the rotational speed of the first multifunctional roller 91 in particular with the printing speed of the printing unit 8 is hereby achieved, with the result that a register-accurate printing is made possible.

By registered or register, or registration accurate or register accurate, or registration accuracy or register accuracy, is meant a positional accuracy of two or more layers relative to each other. The register accuracy is to vary within a predefined tolerance, which is to be as small as possible. At the same time, the register accuracy of several elements and/or layers relative to each other is an important feature for increasing the process reliability. The positionally accurate positioning can be effected in particular by means of sensorily, preferably optically, detectable registration marks or register marks. These registration marks or register marks can either represent special separate elements or areas or layers or themselves be part of the elements or areas or layers to be positioned.

The printing unit 8 shown in FIG. 1a is preferably a UV inkjet printbar.

The UV inkjet printbar expediently has a printing width transverse to the feed direction of the substrate 6 and/or of the transfer product 7 of between 50 mm and 2000 mm, preferably between 100 mm and 1000 mm.

It is also possible that the printing unit 8 is or comprises an inkjet printhead.

It is possible here that the UV inkjet printbar and/or the inkjet printhead has a resolution of from 300 to 1200 npi (nozzles per inch). It is also possible that the UV inkjet printbar and/or the inkjet printhead has a resolution of from 300 to 2400 dpi (dots per inch).

Furthermore, it is possible that the UV inkjet printbar and/or the inkjet printhead has a maximum printing speed of 300 m/min, preferably a maximum printing speed of 200 m/min.

It is also advantageous if the printing unit 8 and/or the UV inkjet printbar has at least two rows of printheads. It is further advantageous if the printing unit 8 has at least two ink receiving devices for receiving at least two different inks.

The printing unit 8 is preferably configured by means of a digital program such that it can print along the two running directions.

As shown in FIG. 1a, the multi-application module 1 can further have one or more deflection rollers and/or one or more guide rollers. The multi-application module 1 shown in FIG. 1a has for example the deflection roller 15, which is used to deflect a substrate 6.

As can further be learned from FIG. 1a, the multi-application module 1 further preferably has two winding rollers 12a and 12b for receiving the transfer product 7.

It is possible here that the two winding rollers 12a and 12b have the same or opposing rotational directions. Thus, it is possible for example that a first 12b of the two winding rollers 12a and 12b is driven clockwise and/or a second 12a of the two winding rollers 12a and 12b is driven counterclockwise. However, it is also possible that a first winding roller 12a of the two winding rollers 12a and 12b and a second winding roller 12b of the two winding rollers 12a and 12b are driven in each case clockwise or counterclockwise. Furthermore, it is possible for example that a first 12b of the two winding rollers 12a and 12b is driven clockwise and/or a second 12a of the two winding rollers 12a and 12b is driven counterclockwise.

FIG. 1b shows, schematically, a top view of a section of FIG. 1a.

As can be learned from the top view, here the printing unit 8 is preferably arranged perpendicular to the surface of the first multifunctional roller 91. The printing nip 10, through which the substrate 6 or the transfer product 7 is guided on the first multifunctional roller 91 in order to be printed on by means of the printing unit, as indicated in FIG. 1b, is arranged between the circumferential edge of the first multifunctional roller 91 and the printing unit 8. The substrate 6 or the transfer product 7 advantageously wraps at least partially around the first multifunctional roller 91, in particular for stable transport in the printing nip 10.

FIG. 1c shows, schematically, a sectional representation of a multi-application device 2.

The multi-application device 2 here comprises a multi-application module 1, which is formed for example as shown in FIG. 1a, and a cold transfer unit 5, wherein the cold transfer unit 5 comprises a pressure roller 17 and a counter-pressure roller 18.

The counter-pressure roller 18 and/or the pressure roller 17 is preferably driven. It is possible here that the counter-pressure roller 18 rotates clockwise or counterclockwise.

The pressure roller 17 can have for example a diameter of between 1 cm and 50 cm, in particular between 5 cm and 20 cm. The pressure roller 17 is preferably formed with a coating of rubber or silicone with a hardness of between 25 Shore A and 100 Shore A, preferably between 50 Shore A and 90 Shore A. It is further expedient if the coating has a thickness of between 1 mm and 20 mm, in particular between 1 mm and 5 mm.

The surface of the counter-pressure roller 18 is preferably made of a material with an abrasion resistance of from 40 Rockwell C to 80 Rockwell C, in particular from 60 Rockwell C to 70 Rockwell C, and can have a diameter of between 5 cm and 70 cm, in particular between 10 and 50 cm. It is further possible that the counter-pressure roller 18 is coated with hard chromium. It is also possible that the counter-pressure roller 18 is cooled.

As shown in FIG. 1c, it is further possible that the cold transfer unit 5 further comprises a UV final curing light source 19a, preferably wherein the UV final curing light source 19a is arranged after the pressure roller 17 and/or the counter-pressure roller 18, in particular in the running direction of the substrate 6 and/or of the transfer product 7. It is possible here that the UV final curing light source 19a is arranged between 5 cm and 20 cm, in particular between 5 cm and 10 cm, downstream of or after the pressure roller 17 and/or the counter-pressure roller 18, in particular in the conveying direction of the substrate 6 and/or of the transfer product 7.

As likewise shown in FIG. 1c, the cold transfer unit 5 preferably further comprises a detachment roller 20, in particular for detaching a carrier ply from a transfer ply of the transfer product 7. It is useful here if the detachment roller 20, in particular in the conveying direction of the substrate 6 and/or of the transfer product 7, is arranged between 5 cm and 50 cm, in particular between 5 cm and 20 cm, downstream of, in the conveying direction of the substrate 6 and/or of the transfer product 7, or after the UV final curing light source 19a. It is also useful if the detachment roller 20, via which the carrier ply can be peeled off, has a diameter of between 0.5 cm and 10 cm. As an alternative to the detachment roller 20, a detachment blade can also be used for detaching a carrier ply from a transfer ply of the transfer product 7.

The UV final curing light source 19a is preferably a UV LED, which in particular generates light from the wavelength range between 100 nm and 420 nm, preferably between 280 nm and 405 nm, further preferably between 280 nm 380 nm, still further preferably between 365 nm and 380 nm. The at least UV final curing light source 19a preferably generates an irradiance of between 5 W/cm² and 50 W/cm², preferably between 15 W/cm² and 25 W/cm².

Furthermore, as can also be learned from FIG. 1c, the cold transfer unit 5 can also further have one or more deflection or guide rollers 15.

FIG. 2a to FIG. 2c show, schematically, a sectional representation of a multi-application module 1 and a sectional representation of a system 4.

The multi-application module 1 shown in FIG. 2a corresponds to the multi-application module 1 shown in FIG. 1a and here serves to illustrate how, in the following FIGS. 2b and 2c, the multi-application module 1 is used in cooperation with the cold transfer unit 5 for applying a transfer ply of a transfer product 7 to a substrate 6. The multi-application module 1 shown in FIG. 2a is therefore a component of the multi-application device 2 shown in FIGS. 2b and 2c or of the system 4 shown in FIGS. 2b and 2c, which in particular has different substrate paths and transfer product paths in FIGS. 2b and 2c.

The system 4 shown in FIGS. 2a and 2b, or the multi-application device 2, is used for applying a transfer ply of a transfer product 7 to a substrate 6, wherein the multi-application module 1 contained in the system 4 or in the multi-application device 2 is used for printing on the substrate 6 or the transfer product 7, in particular with a UV-curable ink.

The system 4 shown FIG. 2b comprises the multi-application device 2 in already shown in FIG. 1c and further a substrate 6 and a transfer product 7. In the variant shown in FIG. 2b, the substrate 6 is first guided in the cold transfer unit 5 along the counter-pressure roller 18 via a deflection roller 15 and from there to the first multifunctional roller 91 via a further deflection roller 15. The substrate 6 wraps around the first multifunctional roller 91 and thus drives it. The substrate 6 is supplied to the printing nip 10, in which the substrate 6 is printed on by means of the printing unit 8, via the first multifunctional roller 91.

The printing is here effected on the substrate 6 by means of a UV-curable ink, which in particular is used as adhesive. The printing can here be effected over the whole surface or only in areas, thus in partial areas. The printing is preferably effected here in the form of a pattern or a motif.

By area or partial area or in areas is meant here in each case a defined surface area of a layer or ply which is occupied when viewed perpendicular to a plane spanned by the substrate 6 or transfer product 7.

The substrate 6 is then supplied to a press nip formed out of pressure roller 17 and counter-pressure roller 18 by bringing the substrate 6 together with the transfer product 7. The printing made of the UV-curable ink is then fully cured through the transfer product 7 by means of the UV final curing light source 19a through the action of the UV light, with the result that, in the printed areas, the transfer product 7 joins to the substrate 6 through full curing. The transfer product 7 is then peeled off the substrate 6 again, with the result that only the transfer ply of the transfer product 7 remains in the areas printed on beforehand. This separation is effected by means of the detachment roller 20. As shown in FIG. 2b, the substrate 6 is then guided out of the cold transfer unit via a deflection roller 15.

In FIG. 2b, the path of the transfer product 7 runs from the winding roller 12a to the press nip, formed out of pressure roller 17 and counter-pressure roller 18, where the transfer product 7, as explained above, is brought together with the substrate 6 and the transfer ply of the transfer product 7 is at least partially transferred to the substrate 6. After the separation, likewise already explained above, of the substrate 6 and the transfer product 7 on the detachment roller 20, the transfer product 7 is supplied to the winding roller 12b, on which the transfer product 7 is wound up again, via a deflection roller 15.

In the variant shown in FIG. 2b, the first multifunctional roller 91 therefore rotates for example clockwise and the printing is effected along this running direction of the substrate 6 predefined by the first multifunctional roller 91.

Thus, according to the variant shown in FIG. 2b, the substrate 6 is guided along the first multifunctional roller 91 to the printing nip 10 formed between the printing unit 8 and the first multifunctional roller 91, which acts as multifunctional element 9, in order to print on the substrate 6 and then guided further to the counter-pressure roller 18 and the pressure roller 17, with which the transfer product 7 is pressed onto the substrate 6.

The system 4 shown FIG. 2c corresponds to the system shown in FIG. 2b, wherein here the substrate path and transfer product path have been changed. The system 4 shown in FIG. 2c therefore likewise comprises the multi-application device 2 already shown in FIG. 1c and further a substrate 6 and a transfer product 7. However, in the variant shown in FIG. 2c, the transfer product 7 is guided from the winding roller 12a via the first multifunctional roller 91. As can be learned from FIG. 2c, here the transfer product 7 wraps around the first multifunctional roller 91 and thus drives it. The transfer product 7 is supplied to the printing nip 10, in which the transfer product 7 is printed on by means of the printing unit 8, via the first multifunctional roller 91.

Here too, the printing is effected on the transfer product 7 by means of a UV-curable ink, which in particular is used as adhesive. This printing can here also be effected over the whole surface or only in areas, thus in partial areas. Here too, the printing is preferably effected in the form of a pattern or a motif.

The transfer product 7 is then supplied to a press nip formed out of pressure roller 17 and counter-pressure roller 18, by bringing the transfer product 7 together with the substrate 6.

In the variant shown in FIG. 2c, the substrate 6 is supplied to the press nip formed out of pressure roller 17 and counter-pressure roller 18 via a deflection roller 15 and the counter-pressure roller 18.

The joining of transfer product 7 and substrate 6 is here effected analogously to the variant in already described in FIG. 2b, with the result that reference is made here to the above statements. The further paths of the substrate 6 and the transfer product 7 also corresponding to the paths already described in connection with FIG. 2b, with the result that reference is also made in this respect to the above statements.

In the variant shown in FIG. 2c, the first multifunctional roller 91 therefore rotates for example counterclockwise and the printing is effected along this running direction of the transfer product 7 predefined by the first multifunctional roller 91.

Thus, according to the variant shown in FIG. 2c, the transfer product 7 is guided along the first multifunctional roller 91 to the printing nip 10 formed between the printing unit 8 and the first multifunctional roller 91, which acts as multifunctional element 9, in order to print on the transfer product 7 and guided further to the counter-pressure roller 18 and pressure roller 17, with which the transfer product 7 is pressed onto the substrate 6.

As can be learned from FIGS. 2b and 2c, in the variants of FIGS. 2b and 2c the first multifunctional roller 91 rotates in each case in an opposing rotational direction.

The printing unit 8 is preferably configured by means of a digital program, with the result that it can print along the two running directions. In other words, it is useful if the printing unit 8 is configured by means of a digital program such that it can print both according to the variant shown in FIG. 2b and according to the variant shown in FIG. 2b.

FIGS. 2b and 2c thus show a (working) method for a multi-application device 2, wherein the multi-application device 2 comprises a multi-application module 1 with a printing unit 8 and a first multifunctional roller 91 as multifunctional element 9, and a cold transfer unit 5 with a pressure roller 17 and a counter-pressure roller 18, wherein a printing nip 10 is formed between the printing unit 8 and the first multifunctional roller 91, wherein, according to a first variant i), a substrate 6 is guided along the first multifunctional roller 91 to the printing nip 10 in order to print on the substrate 6 and is guided further to the counter-pressure roller 18 and the pressure roller 17, with which a transfer product 7 is pressed onto the substrate 6, or wherein, according to a second variant ii), the transfer product 7 is guided along the first multifunctional roller 91 to the printing nip 10 in order to print on the transfer product 7 and is guided further to the counter-pressure roller 18 and pressure roller 17, with which the transfer product 7 is pressed onto the substrate 6, and wherein, in variants i) and ii), the first multifunctional roller 91 rotates in each case in an opposing rotational direction.

As shown in FIGS. 2b and 2c, it is thus possible that both variants i) and ii) can be chosen and/or implemented in the same multi-application device 2 or are implemented by the same multi-application device 2, in particular wherein this is made possible by the multi-application module 1, which comprises a first multifunctional roller 91 mounted rotatable in two opposing rotational directions and the printing unit 8 of which is designed such that it can print along two running directions, which are predefined by the two opposing rotational directions, in the printing nip 10.

FIG. 3 shows, schematically, a sectional representation of a multi-application module 1 and a cold transfer unit 5.

The multi-application module 1 shown in FIG. 3 corresponds to the multifunctional module shown in FIG. 1a, with the result that reference is made to the above statements with respect to its design. The cold transfer unit 5 also corresponds to the cold transfer unit 5 shown in FIG. 1c, with the difference that the cold transfer unit 5 is designed as an extension module 22. The multi-application module 1 can thus be inserted in particular into processing machines, such as for example in a flexographic printing machine, with an already present printing mechanism, here a flexographic printing mechanism, which fulfils the function of the cold transfer unit. With respect to the further design of the cold transfer unit 5, reference is made here to the above statements, for example in connection with FIG. 1c.

Here too, it is possible that an adapter, which in particular makes a mechanically stable fastening of the multi-application module 1 to the cold transfer unit 5 possible, is arranged between the multi-application module 1 and the cold transfer unit 5.

FIG. 4 shows, schematically, a sectional representation of a multi-application device 2.

The multi-application device 2 shown in FIG. 4 here comprises a printing unit 8 and a multifunctional element 9, wherein a printing nip 10 is formed between the printing unit 8 and the multifunctional element 9. In this design variant the multifunctional element comprises a first multifunctional roller 91 and a printing table 13 arranged above it. The printing nip 10 is therefore preferably formed between the printing unit 8 and the printing table 13.

In order to make it possible to print on both a substrate 6 or a transfer product 7 by means of the multi-application device 2, the first multifunctional roller 91 is here mounted rotatable in two opposing rotational directions. The printing unit 8 is further designed such that it can print along two running directions, which are predefined by the two opposing rotational directions, in the printing nip 10.

With respect to the further design of the printing unit 8 and the first multifunctional roller 91, reference is made here to the above statements, for example in connection with FIG. 1a.

Furthermore, the multi-application device 2 shown in FIG. 4 here comprises the winding rollers 12a and 12b, wherein reference is also made here to the above statements with respect to its design.

As is shown FIG. 4, the multi-application device 2 can further have one or more clamping systems 16 for clamping the transfer product 7, wherein the clamping systems 16 are selected individually or in combination. The clamping system can have one or more of the following elements, selected individually or in combination from: dancer roller, controlled dancer roller, measuring roller, friction shaft.

The printing table 13 shown in FIG. 4 is arranged such that the substrate 6 or the transfer product 7 can be guided over the printing table 13.

The printing table 13 preferably forms a flat surface area, in particular of between 250 mm² and 1,000,000 mm², preferably between 1000 mm² and 200,000 mm².

Furthermore, it is preferred if the printing table 13 is arranged perpendicular to the printing unit 8. It is also possible that ink is ejected from the printing unit 8 perpendicularly, i.e. vertically, relative to the flat surface area of the printing table. It is furthermore also possible that the printing table has a length in the feed direction of the substrate 6 and/or of the transfer product 7 of between 5 mm and 500 mm, in particular between 10 mm and 100 mm, and/or a width transverse with respect to the feed direction of the substrate 6 and/or of the transfer product 7 of between 50 mm and 2000 mm, in particular between 100 mm and 1000 mm. It is also useful if the distance between the printing unit 8 and the flat printing surface of the substrate 6 or the transfer product 7, which is guided over the printing table 13, is between 0.1 mm and 5 mm, preferably between 0.5 mm and 3 mm.

It is also possible that the printing table 13 has air outlets for generating an air cushion, in particular an air cushion between the printing table 13 and the substrate 6 or the transfer product 7.

As already explained above, a UV-curable ink is preferably printed by means of the printing unit 8.

It is useful here that the multi-application device 2 further has at least one UV precuring light source 14, preferably wherein in each case one UV precuring light source 14 is arranged on each side of the printing unit 8, in particular along the two running directions. It is also possible that the at least one UV precuring light source 14 is arranged remountable, in particular reconnectable, on each side of the printing unit 8, in particular along the two running directions. The UV-curable ink can be fixed by means of the UV precuring light sources 14, in order to prevent the UV-curable ink from running during the further transport of the substrate 6 or of the transfer product 7 to the press nip formed out of the pressure roller 17 and the counter-pressure roller 18.

The multi-application device 2 shown in FIG. 4 here has two UV precuring light sources 14, on each side of the printing unit 8.

The at least one UV precuring light source 14 is preferably a UV LED, which in particular generates light from the wavelength range between 100 nm and 420 nm, preferably between 280 nm and 405 nm, further preferably between 280 nm 380 nm, still further preferably between 365 nm and 380 nm.

The distance between the UV precuring light source 14 and the, in particular printed, substrate 6 or transfer product 7 is further preferably between 1 mm and 50 mm, preferably between 3 mm and 20 mm.

It is also expedient if the distance between the UV precuring light source 14 and the printing unit 8 or the printing table 13 is between 10 mm and 500 mm, preferably between 30 mm and 100 mm.

The at least one UV precuring light source 14 preferably generates an irradiance of between 0 W/cm² and 10 W/cm², preferably between 0.5 W/cm² and 7.5 W/cm², further preferably between 2 W/cm² and 5 W/cm².

The multi-application device 2 shown in FIG. 4 further also has a pressure roller 17, a counter-pressure roller 18, a detachment roller 20 and a UV final curing light source 19a, with respect to the design of which reference is made here to the above statements. Furthermore, the multi-application device 2 shown in FIG. 4 also has the deflection and guide rollers 15, by means of which a substrate 6 or a transfer product 7 are guided through the multi-application device 2.

The multi-application device shown in FIG. 4 here comprises the further UV final curing light source 19b. The further UV final curing light source 19b is here arranged after the detachment roller 20, in particular in the running direction of the substrate 6. Thus, it is useful if the further UV final curing light source 19b is arranged between 5 cm and 50 cm, in particular between 5 cm and 20 cm, downstream of or after the detachment roller 20, in particular in the conveying direction of the substrate 6. With respect to the further design of the further UV final curing light source 19b, reference is made here to the above statements in connection with the UV final curing light source 19a.

As is shown in each case by the dashed line in the following FIGS. 5a and 5b as well as FIGS. 6a and 6b, here the multi-application device 2 shown in FIG. 4 also has a multi-application module 1 and a cold transfer unit 5, wherein the multi-application module 1 comprises at least the printing unit 8 and the multifunctional element 9 together with the associated printing nip 10, and wherein the cold transfer unit 5 comprises at least the pressure roller 17 and the counter-pressure roller 18. In addition, the multifunctional element 9 shown in FIG. 4 comprises a first multifunctional roller 9 and a printing table 13 arranged above it. The associated printing nip 10 is thus formed between the printing unit 8 and the printing table 13.

FIGS. 5a and 5b shows, schematically, a sectional representation of a system 4. The system 4 here also comprises, in addition to the multi-application device 2, a substrate 6 and a transfer product 7, wherein the substrate path and transfer product path differ in each case between the variant of the system 4 shown in FIG. 5a and the variant of the system 4 shown in FIG. 5b. FIGS. 5a and 5b therefore also show, schematically, sectional representations of a multi-application device 2 which in particular further have a substrate 6 and a transfer product 7. Thus, a (working) method of a multi-application device 2 which comprises the variants shown in FIGS. 5a and 5b is also shown in FIGS. 5a and 5b.

According to the variant shown in FIG. 5a of a (working) method for a multi-application device, a substrate 6 is guided along a multifunctional element 9 to a printing nip 10 formed between a printing unit 8 and the multifunctional element 9 in order to print on the substrate 6. The multifunctional element 9 comprises a first multifunctional roller 91 and a printing table 13 arranged above it. The printing nip 10 is therefore formed between the printing unit 8 and the printing table 13. The substrate 6 is further guided to a counter-pressure roller 18 and a pressure roller 17. with which a transfer product 7 is pressed onto the substrate 6. According to the variant shown in FIG. 5b of the (working) method for a multi-application device 2, the transfer product 7 is guided along the multifunctional element 9 to the printing nip 10 formed between the printing unit 8 and the multifunctional element 9 in order to print on the transfer product 7. The multifunctional element 9 comprises a first multifunctional roller 91 and a printing table 13 arranged above it. The printing nip 10 is therefore formed between the printing unit 8 and the printing table 13. The transfer product 7 is further guided to the counter-pressure roller 18 and pressure roller 17, with which the transfer product 7 is pressed onto the substrate 6. In the variants shown in FIGS. 5a and 5b of the (working) methods for a multi-application device 2, the first multifunctional roller 91 rotates in each case in an opposing rotational direction.

Thus, in the variant shown in FIG. 5a, the substrate 6 first runs, via a deflection roller 15, a short distance along the counter-pressure roller 18 to the first multifunctional roller 91. From the first multifunctional roller 91, the substrate 6 is then guided over the printing table 13, on which the printing procedure takes place in the printing nip 10, which is formed between the printing table 13 or the multifunctional element 9 and the printing unit 8, by means of the printing unit 8. A UV-curable ink is preferably used as printing material here. From the printing table 13, the substrate 6 is guided back to the first multifunctional roller 91 again, which the substrate 6 wraps partially around, with the result that the substrate 6 can drive the first multifunctional roller 91. After the printing procedure in the printing nip 10, the printed material is fixed by means of the UV precuring light source 14. The UV precuring light source 14 is therefore arranged downstream of the printing. The substrate 6 is then brought together with the transfer product 7 in the press nip formed between pressure roller 17 and counter-pressure roller 18 and pressed on. For this, the transfer product 7 is guided from the winding roller 12a via a clamping system 16 and a deflection roller 15 to the press nip. By means of the clamping systems 16, a transport of the transfer product 7 under tension can be guaranteed here. As shown in FIG. 5a, the substrate 6 and the transfer product 7 now simultaneously cover a common segment on the counter-pressure roller 18. On this common segment, the printing is fully cured through the transfer product 7 by means of a UV final curing light source 19a. Through the full curing, the transfer product 7, or the transfer ply of the transfer product 7, joins to the substrate 6 in those areas in which the printing, in particular thus the UV-curable ink, was applied beforehand. As shown in FIG. 5a, the transfer product 7 is then separated from the substrate 6 again by means of the detachment roller 20, wherein the transfer ply of the transfer product 7 remains on the substrate 6 in the areas printed on beforehand. The transfer product 7 is then wound onto the winding roller 12b via a deflection roller 15 and a clamping system 16. The substrate 6 that is now decorated with the transfer ply 7 at least in areas is guided out of the system 4 or the multi-application device 2 via a deflection roller 15.

In contrast, in the variant shown in FIG. 5b, the substrate 6 is guided onto the counter-pressure roller 15, which the substrate 6 wraps at least partially around, via a deflection roller 15. On the counter-pressure roller 15, the substrate 6 is now guided to the press nip formed out of pressure roller 17 and counter-pressure roller 18. In contrast, the transfer product 7 is guided from the winding roller 12a via a clamping system 16 and a deflection roller 15 to the first multifunctional roller 91. From the first multifunctional roller 91, the transfer product 7 is then guided over the printing table 13, on which the printing procedure takes place in the printing nip, which is formed between the printing table 13 or the multifunctional element 9 and the printing unit 8, by means of the printing unit 8. A UV-curable ink is preferably used as printing material here. From the printing table 13, the transfer product 7 is guided back onto the first multifunctional roller 91 again, which the transfer product 7 wraps partially around, with the result that the transfer product 7 can drive the first multifunctional roller 91. After the printing procedure in the printing nip 10, the printed material is fixed by means of the UV precuring light source 14. The UV precuring light source 14 is therefore arranged downstream of the printing. The UV precuring light source 14 shown in FIGS. 5a and 5b is thus a remountable UV precuring light source 14, which can be attached on each side of the printing unit 8 depending on whether it is now the substrate 6 or the transfer product 7 that is to be printed on. The transfer product 7 is then brought together with the substrate 6 in the press nip formed between pressure roller 17 and counter-pressure roller 18 and pressed on. As shown in FIG. 5b, the substrate 6 and the transfer product 7 now simultaneously cover a common segment on the counter-pressure roller 18. On this common segment, the printing is fully cured through the transfer product 7 by means of a UV final curing light source 19a. Through the full curing, the transfer product 7, or the transfer ply of the transfer product 7, joins to the substrate 6 in those areas in which the printing, in particular thus the UV-curable ink, was applied beforehand. As shown in FIG. 5b, the transfer product 7 is then separated from the substrate 6 again by means of the detachment roller 20, wherein the transfer ply of the transfer product 7 remains on the substrate 6 in the areas printed on beforehand. The transfer product 7 is then wound onto the winding roller 12b via a deflection roller 15 and a clamping system 16. The substrate 6 that is now decorated with the transfer ply at least in areas is guided out of the system 4 or the multi-application device 2 via a deflection roller 15.

With respect to the design of the component parts or components shown in FIGS. 5a and 5b, reference is made here to the above statements, for example in the context of FIG. 4.

Corresponding to the system 4 which comprises a multi-application device 2 with a multi-application module 1 and a cold transfer unit 2 and further also comprises a substrate 6 and a transfer product 7, the printing system 3 likewise shown in FIGS. 5a and 5b is the multi-application module 1 shown in FIGS. 5a and 5b, which further also comprises the substrate 6 and/or the transfer product 7.

As shown in FIGS. 5a and 5b, the substrate 6 or the transfer product 7 can thus be guided by means of the first multifunctional roller 91. It is thus possible that the substrate 6 guided on the first multifunctional roller 91 or the transfer product 7 guided on the first multifunctional roller 91 can be printed on in two opposing running directions in the printing nip 10 by means of the printing unit 8, in particular wherein the rotational directions of the first multifunctional roller 91 are opposing during the guiding of the substrate 6 and the transfer product 7.

As can be learned from FIGS. 5a and 5b, both the variant shown in FIG. 5a and the variant shown in FIG. 5b are carried out by the same multi-application device 2 or the same system 4, in particular wherein the substrate path and the transfer product path inside the multi-application device 2 differ, as described above. The printing on the substrate 6 or on the transfer product 7 is thus effected in the same multi-application module 1, wherein the substrate running direction and the transfer product running direction or transport directions differ, in particular are opposing.

Further, in the variant shown in FIG. 5a the first multifunctional roller 91 rotates clockwise, whereas in the variant shown in FIG. 5b the first multifunctional roller 91 rotates counterclockwise. As shown in FIGS. 5a and 5b, the counter-pressure roller 18 here rotates clockwise in both variants.

As can be learned from the above statements, according to the variant shown in FIG. 5a the substrate 6 is here consequently printed on and then brought together with the transfer product 7 with one and the same machine, whereas according to the variant shown in FIG. 5b the transfer product 7 is printed on and is then brought together with the substrate 6.

FIGS. 6a and 6b shows, schematically, a sectional representation of a system 4.

The system 4 shown in FIGS. 6a and 6b corresponds to the system shown in FIGS. 5a and 5b, with the difference that one or more component parts selected from the group: pressure roller 17, at least one UV final curing light source 19a, detachment roller 20 and optionally at least one further UV final curing light source 19b is displaceable pivotably about the counter-pressure roller 18, in particular for adapting a feeding angle α of the transfer product 7 into a press nip formed out of pressure roller 17 and counter-pressure roller 18.

As can be learned from FIGS. 6a and 6b and is indicated by an arrow, the pressure roller 17, UV final curing light source 19a and detachment roller 20 shown in FIG. 6b are pivoted compared with the pressure roller 17, UV final curing light source 19a and detachment roller 20 shown in FIG. 6a such that the feeding angle α into the press nip can comply with a minimum value in both variants shown in FIGS. 6a and 6b.

FIGS. 7a and 7b shows, schematically, a sectional representation of a system 4.

The system 4 shown in FIGS. 7a and 7b corresponds to the system shown in FIGS. 5a and 5b, with the difference that the cold transfer unit 5 is displaceable relative to the multi-application module 1, in particular for adapting a feeding angle α of the transfer product 7 into a press nip formed out of pressure roller 17 and counter-pressure roller 18.

As can be learned from FIGS. 7a and 7b and is indicated by an arrow, the cold transfer unit 5 shown FIG. 7b has been displaced such that the feeding angle α into the press nip can comply with a minimum value in both variants shown in FIGS. 7a and 7b.

Various embodiments of the multifunctional element 9 of a multi-application module 1 are shown by way of example in FIGS. 8a to 8f. In each representation, a printing unit 8 is additionally arranged above the multifunctional element 9, whereby the positioning of the multifunctional element 9 relative to the printing unit 8 is to be illustrated.

In FIG. 8a, the multifunctional element 9 merely comprises the first multifunctional roller 91. The printing nip is thus formed between the printing unit 8 and the first multifunctional roller 91. The substrate 6 or the transfer product 7 preferably wraps at least partially around the first multifunctional roller 91, with the result that the multifunctional roller 91 is driven by the substrate 6 or the transfer product 7. Ink is preferably ejected from the printing unit 8 vertically relative to the circumferential edge of the first multifunctional roller 91. In this embodiment it is preferably provided that the first multifunctional roller 91 has as large a diameter as possible, with the result that the curvature is as slight as possible in the printing area. A high print quality is thereby guaranteed. The first multifunctional roller 91 shown in FIG. 8a is mounted rotatable and can therefore rotate in two opposing rotational directions. As described above, the rotational direction is dependent on whether a substrate 6 or a transfer product 7 is printed on.

In FIG. 8b, the multifunctional element 9 comprises a first multifunctional roller 91 and a printing table 13 arranged above it. The printing nip we thus formed between the printing unit 8 and the printing table 13. As also in the case of the design according to FIG. 8a, the substrate 6 or the transfer product 7 wraps at least partially around the first multifunctional roller 91, with the result that the first multifunctional roller 91 is driven by the substrate 6 or the transfer product 7. As represented in FIG. 8b, the substrate 6 or the transfer product 7 is guided over the printing table 13. The printing table 13 then preferably forms a flat surface area, which acts as printing surface. Printing on a flat surface area ensures a high print quality and print accuracy.

In FIG. 8c, the multifunctional element 9 merely comprises a printing table 13. In the design shown in FIG. 8c, the printing nip 10 is thus also formed between the printing unit 8 and the printing table 13. The substrate 6 or the transfer product 7 is guided over the printing table 13. In preferred designs it is possible that the printing table 13 itself has rollers and/or rolls, which are in particular integrated in the printing table 13, in order to make better running properties of the substrate 6 or of the transfer product 7 possible.

In FIG. 8d, the multifunctional element 9 comprises a first multifunctional roller 91 and two second multifunctional rollers 92. The substrate 6 or the transfer product 7 wraps at least partially around the first multifunctional roller 91, whereby the first multifunctional roller 91 is driven. After the first point at which the substrate 6 or the transfer product 7 touches the first multifunctional roller, the substrate 6 or the transfer product 7 is guided onto the first second multifunctional roller 92 and diverted back to the first multifunctional roller 91 via the second second multifunctional roller 92. This means that the substrate 6 or the transfer product 7 is clamped between the two second multifunctional rollers 92 in such a way that the substrate 6 or the transfer product 7 forms a flat printing surface. In the embodiment shown in FIG. 8d, the printing nip 10 is formed between the flat printing surface, or between the two second multifunctional rollers 92, and the printing unit 8. A high print quality and print accuracy is also promoted by clamping the substrate 6 or the transfer product 7 by means of the second multifunctional rollers to form a flat printing surface. Both the first multifunctional roller 91 and the second multifunctional rollers 92 are preferably mounted rotatable in two opposing rotational directions. As described previously, the rotational direction is dependent on whether the substrate 6 or the transfer product 7 is printed on.

In FIG. 8e, the multifunctional element 9 comprises two second multifunctional rollers 92. The substrate 6 or the transfer product 7 wraps at least partially around the two second multifunctional rollers 92 and they are thereby driven. As already shown in

FIG. 8d, in the embodiment according to FIG. 8e the substrate 6 or the transfer product 7 is also clamped between the two second multifunctional rollers 92 to form a flat printing surface. This makes a high print quality and print accuracy possible. The second multifunctional rollers 92 are preferably mounted rotatable in two opposing rotational directions, which are dependent on whether the substrate 6 or the transfer product 7 is printed on.

In FIG. 8f, the multifunctional element 9 comprises a first multifunctional roller 91 and one second multifunctional roller 92. The substrate 6 or the transfer product 7 wraps at least partially around both the first multifunctional roller 91 and the second multifunctional roller 92, which are driven by the substrate 6 or the transfer product 7. In the design shown in FIG. 8f, the substrate 6 or the transfer product 7 is clamped via the first multifunctional roller 91 and the one second multifunctional roller 92 such that a flat printing surface forms. The flat printing surface is preferably arranged vertically in relation to the printing unit 8 or arranged vertically in relation to the ejection of ink by the printing unit 8. The first multifunctional roller 91 and the second multifunctional roller 92 are preferably mounted rotatable in two opposing rotational directions in each case, which is dependent on whether the substrate 6 or the transfer product 7 is printed on.

FIGS. 9a and 9b in each case show a schematic sectional representation of a system 4. The systems shown in FIGS. 9a and 9b substantially correspond to the systems shown in FIGS. 6a and 6b, but with the difference that the transfer product 7 is in each case conveyed, using a transfer product transport system 24, in the direction of the press nip, which is formed between pressure roller 17 and counter-pressure roller 18.

FIGS. 9a and 9b also show, schematically, sectional representations of a multi-application device 2, which in particular further have a substrate 6 and a transfer product 7. Thus, a (working) method of a multi-application device 2 which comprises the variants shown in FIGS. 9a and 9b is also shown in FIGS. 9a and 9b.

Since only the transport path of the transfer product 7 in FIGS. 9a and 9b differs from the transport path of the transfer product 7 represented in FIGS. 6a and 6b, only these changed transport paths are described, in order to avoid repetitions. In contrast, the transport path of the substrate 6 is identical to that from FIGS. 6a and 6b. The arrangement of the remaining components of the multi-application device 2 and of the system 4 are also identical to the arrangements in FIGS. 6a and 6b.

Thus, in the variant of a (working) method shown in FIG. 9a, the transfer product 7 runs, starting from a winding roller 12a, via a clamping system 16 along a multifunctional element 9 to a printing nip 10 formed between a printing unit 8 and the multifunctional element 9 in order to print on the transfer product 7. In this variant the multifunctional element 9 comprises a first multifunctional roller 91 and a printing table 13 arranged above it. The transfer product 7 is further guided by the transfer product transport system 24 to a counter-pressure roller 18 and a pressure roller 17, with which the transfer product 7 is pressed onto a substrate 6. The transfer product 7 is separated from the substrate 6 again by means of a detachment roller 20, wherein the transfer ply remains on the substrate 6 in the areas printed on beforehand. The transfer product 7 is then wound onto the winding roller 12b via a deflection roller 15 and a clamping system 16.

Because the transfer product transport system 24 is arranged upstream of the counter-pressure roller 18, the transfer product 7 can be arranged in register with the substrate 6 using the transfer product transport system 24. The functioning of the transfer product transport system 24 is described below in relation to the statements relating to FIG. 9b.

In the variant of a (working) methods shown in FIG. 9b, the transfer product 7 is, starting from a winding roller 12a, via a clamping system 16, by a transfer product transport system 24 to a counter-pressure roller 18, on which the transfer product 7 pressed against a substrate 6 by means of a pressure roller 17. As also shown in FIG. 9a, the transfer product 7 is then separated from the substrate 6 again by means of the detachment roller 20, wherein the transfer ply of the transfer product 7 remains on the substrate 6 in the areas printed on beforehand. The transfer product 7 is then wound onto the winding roller 12b via a deflection roller 15 and a clamping system 16.

The material transport can be exactly controlled by the transfer product transport system 24 arranged after the clamping system 16. The transfer product transport system 24 preferably controls the positioning in the press nip of an at least one element and/or an at least one layer on the transfer product 7 and an at least one element and/or an at least one layer on the substrate 6 in a register-accurate manner by means of the stretching of the transfer product 7. The at least one element and/or the at least one layer on the transfer product 7 and/or on the substrate 6 is preferably already applied in the production process of the transfer product 7 or of the substrate 6. In addition, optically detectable registration marks or register marks are applied to the at least one element and/or the at least one layer of the transfer product 7 or of the substrate 6. These registration marks or register marks can be detected by a detection unit arranged in the transfer product transport system 24 and the position of the at least one element and/or the at least one layer on the transfer product 7 can be determined therefrom. With the aid of these data, a roller driven in the transfer product transport system 24 is accelerated or decelerated, as a result of which the transport speed of the transfer product 7 changes locally in relation to the overall transport speed of the transfer product 7. Because the transfer product 7 is stretchable up to a certain degree, a register-accurate application of the transfer product 7 relative to the substrate 6 or to the printing on the substrate 6 and/or the at least one element and/or the at least one layer on the substrate 6 can be achieved via the local transport speed of the transfer product 7. Such a driven roller can have one or more of the following elements, selected individually or in combination from: roller with opposing pressure roller, roller with at least one or more segmented pressure roller, or vacuum roller.

The transfer product transport system 24 can also have a clamping system, with which the stretching of the transfer product 7 can be further influenced. It is thus possible that the transport speed of the transfer product 7 upstream of the transfer product transport system 24 is different from that downstream of the transfer product transport system 24. The stretching of the transfer product 7 thus makes the registered positioning of the transfer product 7 possible.

### LIST OF REFERENCE NUMBERS

1 multi-application module
2 multi-application device
3 printing system
4 system
5 cold transfer unit
6 substrate
7 transfer product
8 printing unit
9 multifunctional element
91 first multifunctional roller
92 second multifunctional roller
10 printing nip
11a, 11b running directions
12a, 12b winding rollers
13 printing table
14 UV precuring light source
15 deflection and/or guide roller
16 clamping system
17 pressure roller
18 counter-pressure roller
19a, 19b UV final curing light source
20 detachment roller or a detachment blade
21 section
22 extension module
23 processing machine
24 transfer product transport system

1. A multi-application module for printing on a substrate or a transfer product, comprising a printing unit and a multifunctional element, wherein a printing nip is formed between the printing unit and the multifunctional element, and
wherein the multifunctional element has a first multifunctional roller and/or at least one second multifunctional roller and/or a printing table,
and wherein the printing unit is designed such that it can print along two running directions in the printing nip,
and wherein the printing unit is or comprises a UV inkjet printbar and/or wherein the printing unit comprises at least one inkjet printhead,
and wherein the printing on the substrate or on the transfer product is effected with the same printing unit in the same printing nip,
and wherein, if the first multifunctional roller and/or the at least one second multifunctional roller is rotated in a first rotational direction, the substrate guided on the first multifunctional roller and/or the at least one second multifunctional roller can be printed on in the printing nip, in a first running direction, or wherein, if the first multifunctional roller and/or the at least one second multifunctional roller is rotated in a second rotational direction, opposing the first rotational direction, the transfer product guided on the first multifunctional roller and/or the at least one second multifunctional roller can be printed on in the printing nip, in a second running direction, opposing the first direction.

2. The multi-application module according to claim 1, wherein the multi-application module further has two winding rollers for receiving the transfer product.

3. The multi-application module according to claim 1, wherein
the multi-application module further has a clamping system for clamping the transfer product, wherein the clamping system has one or more of the following elements, selected individually or in combination from: dancer roller, controlled dancer roller, measuring roller, friction shaft.

4. The multi-application module according to claim 1, wherein
the first multifunctional roller and/or the at least one second multifunctional roller is mounted rotatable in two opposing rotational directions.

5. The multi-application module according to claim 1, wherein
the first multifunctional roller in combination with a second multifunctional roller and/or the first multifunctional roller in combination with two second multifunctional rollers and/or two second multifunctional rollers are arranged such that the substrate or the transfer product can be guided via the first multifunctional roller and/or the at least one second multifunctional roller and thereby forms a flat printing surface.

6. The multi-application module according to claim 5, wherein
the flat printing surface is arranged perpendicular to the printing unit and/or forms a surface area with a size of between 250 mm² and 1,000,000 mm².

7. The multi-application module according to claim 1, wherein
the printing table is arranged such that the substrate or the transfer product can be guided over the printing table.

8. The multi-application module according to claim 1, wherein
the printing table forms a flat surface area, and/or wherein the printing table is arranged perpendicular to the printing unit.

9. The multi-application module according to claim 1, wherein
the printing table has air outlets for generating an air cushion.

10. The multi-application module according to claim 1, wherein
the multi-application module further has at least one UV precuring light source.

11. The multi-application module according to 10, wherein
the at least one UV precuring light source generates an irradiance of between 0 W/cm² and 10 W/cm².

12. The multi-application module according to claim 1, wherein
the surface of the first multifunctional roller and/or of the at least one second multifunctional roller has a surface structure generated by a surface finishing process and/or wherein the first multifunctional roller and/or the at least one second multifunctional roller has an anti-slip coating and/or a traction coating.

13. The multi-application module according to claim 1, wherein
the printing unit and/or the UV inkjet printbar has at least two rows of printheads and/or wherein the printing unit has at least two ink receiving devices for receiving at least two different inks.

14. The multi-application module according to claim 6, wherein
ink is ejected from the printing unit perpendicularly,
relative to the surface of the multifunctional element.

15. The multi-application module according to claim 1, wherein
the substrate or the transfer product can be guided by means of the first multifunctional roller and/or the at least one second multifunctional roller and/or wherein the first multifunctional roller and/or the at least one second multifunctional roller is formed for guiding the substrate or the transfer product.

16. The multi-application module according to claim 1, wherein
the substrate guided on the first multifunctional roller and/or the at least one second multifunctional roller or the transfer product guided on the first multifunctional roller and/or the at least one second multifunctional roller can be printed on along the two running directions in the printing nip by means of the printing unit.

17. The multi-application module according to claim 1, wherein
the substrate or the transfer product is guided on the same first multifunctional roller and/or at least one second multifunctional roller.

18. The multi-application module according to claim 1, wherein
the multi-application module has a changeable substrate path and/or transfer product path.

19. The multi-application module according to claim 1, wherein
the multi-application module comprises at least one detection unit, which detects the position of at least one element and/or at least one layer on the substrate and/or the transfer product, wherein the detection unit is connected to a control device, which controls the printing unit on the basis of the position data detected by the detection unit such that the printing on the substrate and/or the transfer product is effected in register with the at least one element and/or the at least one layer.

20. A multi-application device comprising a multi-application module according to claim 1 and a cold transfer unit, wherein the cold transfer unit comprises a pressure roller and a counter-pressure roller.

21. The multi-application device according to claim 20, wherein
the pressure roller is formed with a coating of rubber or silicone with a hardness of between 25 Shore A and 100 Shore A.

22. The multi-application device according to claim 20, wherein
the cold transfer unit further comprises at least one UV final curing light source.

23. The multi-application device according to claim 20, wherein
the cold transfer unit further comprises a detachment roller or a detachment blade.

24. The multi-application device according to claim 20, wherein,
the cold transfer unit further comprises at least one further UV final curing light source.

25. The multi-application device according to claim 20, wherein
one or more component parts selected from the group: pressure roller, at least one UV final curing light source, detachment roller or detachment blade, at least one further UV final curing light source are pivotable about the counter-pressure roller, or wherein the cold transfer unit is displaceable relative to the multi-application module.

26. The multi-application device according to claim 20, wherein
the pressure roller and/or the counter-pressure roller is driven.

27. The multi-application device according to claim 20, wherein
the cold stamping unit is designed as an extension module, which can be inserted into a processing machine.

28. The multi-application device according to claim 20, wherein
the cold stamping unit comprises at least one detection unit, which detects the position of at least one element and/or at least one layer on the substrate and/or the transfer product, and the positioning is effected via the stretching of the transfer product, with the result that, after the transport of the transfer product to the press nip, the pressure roller presses the at least one element and/or the at least one layer on the transfer product onto the at least one element and/or the at least one layer on the substrate in register.

29. The multi-application device according to claim 20, wherein
the multi-application device has a transfer product transport system with a clamping system for the controlled transport of material, wherein the transfer product transport system controls the register-accurate positioning in the press nip of the at least one element and/or the at least one layer on the transfer product and the at least one element and/or the at least one layer on the substrate via the stretching of the transfer product by means of the clamping system.

30. The multi-application device according to claim 20, wherein
the multi-application device has a transfer product transport system for the controlled transport of material, wherein the transfer product transport system controls the register-accurate positioning in the press nip of the at least one element and/or the at least one layer on the transfer product and the at least one element and/or the at least one layer on the substrate via the stretching of the transfer product by means of a driven vacuum roller.

31. The multi-application device according to claim 29, wherein
the transfer product transport system at least one driven roller influencing the transport speed of the transfer product and a detection unit, for recognizing the position of the at least one element and/or the at least one layer on the transfer product by means of an optically detectable registration mark or register mark applied to the transfer product.

32. A working method for a multi-application device, according to claim 20, wherein
according to a first variant i), a substrate is guided along a multifunctional element to a printing nip formed between a printing unit and the multifunctional element in order to print on the substrate and is guided further to the one counter-pressure roller and a pressure roller, with which a transfer product is pressed onto the substrate, or
wherein, according to a second variant ii), the transfer product is guided along the multifunctional element to the printing nip formed between the printing unit and the multifunctional element in order to print on the transfer product and is guided further to the counter-pressure roller and the pressure roller, with which the transfer product is pressed onto the substrate,
and wherein the substrate and/or the transfer product, in variants i) and ii), are guided in each case in an opposing running direction.

33. The working method according to claim 32, wherein
in the first variant i) the counter-pressure roller is rotated in a rotational direction corresponding to the running direction of the substrate in the multifunctional element and wherein in the second variant ii) the counter-pressure roller is rotated in an opposing rotational direction corresponding to the running direction of the transfer product in the multifunctional element.

34. The working method according to claim 32, wherein
the multifunctional element has a first multifunctional roller and/or at least one second multifunctional roller and/or a printing table.

35. The working method according to claim 34, wherein
the first multifunctional roller and/or the at least one second multifunctional roller is mounted rotatable in two opposing rotational directions.

36. The working method according to claim 32, wherein
the counter-pressure roller and/or the pressure roller are driven.

37. The working method according to claim 32, wherein
the transfer product is unwound from a first of two winding rollers and is wound onto a second of two winding rollers.

38. The working method according to claim 32, wherein
the substrate or the transfer product is printed on in each case on the side of the substrate or of the transfer product facing away from the surface of the first multifunctional roller and/or of the at least one second multifunctional roller and/or of the printing table.

39. The working method according to claim 32, wherein
the printing on the substrate or on the transfer product is effected in the same printing nip and/or wherein the pressing of the transfer product onto the substrate is effected with the same counter-pressure roller and the same pressure roller.

40. The working method according to claim 32, wherein
in the first variant i), the substrate comprises at least one element and/or at least one layer, on which the printing is positioned as a further layer in register with this at least one element and/or with the at least one layer.

41. The working method according to claim 32, wherein
in the second variant ii), the substrate comprises at least one element and/or at least one layer, wherein a printing applied to the transfer product is positioned relative thereto.

42. The working method according to claim 32, wherein
in the first variant i), the substrate comprises at least one element and/or at least one layer, in register with which the printing is positioned as a further layer.

43. The working method according to claim 32, wherein
the at least one element and/or the at least one layer on the transfer product is pressed, in the press nip between counter-pressure roller and pressure roller, in register with the at least one element and/or with the at least one layer and/or with the printing on the substrate.

44. The working method according to claim 32, wherein
in the second variant ii), the substrate comprises at least one element and/or at least one layer, in register with which at least one element and/or at least one layer on the transfer product is pressed, in the press nip between counter-pressure roller and pressure roller, onto the at least one element or the at least one layer on the substrate.
